(19) United States
(12) Patent Application Publication
(10) Pub. No.: US 2024/0272284 A1
(43) Pub. Date: Aug. 15, 2024

(54) CONTROL DEVICE AND CONTROL METHOD

(71) Applicant: SONY SEMICONDUCTOR SOLUTIONS CORPORATION, KANAGAWA (JP)

(72) Inventor: SHOJI SETA, KANAGAWA (JP)

(21) Appl. No.: 18/568,302

(22) PCT Filed: Mar. 10, 2022
(86) PCT No.: PCT/JP2022/010640

§ 371 Date: Dec. 8, 2023

(30) Foreign Application Priority Data
Jun. 17, 2021 (JP) 2021-100903

(51) Int. Cl. G01S 7/484; G01S 17/46; G01S 17/894

(52) U.S. Cl. CPC G01S 7/484; G01S 17/46; G01S 17/894

(57) ABSTRACT

A control device according to the present technique includes a control unit that performs switching control among at least two types of light emission patterns of a light-emitting unit in a sensing module, the sensing module including the light-emitting unit and a sensor unit configured to be capable of a light reception operation compatible with an indirect ToF method for light emitted from the light-emitting unit and reflected by an object.

### TECHNICAL FIELD

The present technique relates to a control device and method for controlling a light emission pattern of a light-emitting unit in a sensing module which includes the light-emitting unit and a sensor unit configured to be capable of light reception operations compatible with an indirect Time of Flight (ToF) method for light emitted from the light-emitting unit and reflected by an object.

### BACKGROUND ART

There is demand for the ability to obtain range images and gradation images using a common sensor. Here, “range image” refers to an image that indicates distance information for each pixel, whereas “gradation image” refers to an image that indicates light reception intensity information for each pixel.

For example, when monitoring the state of a driver or the like in in-vehicle monitoring applications, various processing is assumed to be performed for the occupants, including authentication processing such as facial authentication and iris authentication, processing for detecting posture such as driving posture, processing for detecting forgotten items, and the like.

Of this processing, authentication processing may use only range images or only gradation images, or may use both. Range images may be used for posture detection processing. Gradation images may be used for forgotten item detection processing. Thus, with in-vehicle monitoring, there is demand to obtain both range images and gradation images using sensors.

In this case, it is conceivable to separately provide a sensor for obtaining a range image and a sensor for obtaining a gradation image, but doing so increases the number of sensors and by extension, the cost, which is undesirable. Accordingly, it is desirable to use a sensor capable of obtaining both range images and gradation images.

The following patent literature can be given as an example of a related conventional technique. PTL 1 discloses a technique for performing in-vehicle monitoring based on an image obtained by a ToF sensor.

### CITATION LIST

### Patent Literature

### [PTL 1]

JP 2018-205288A

### SUMMARY

### Technical Problem

Here, a sensor compatible with the indirect ToF method can be configured to be capable of obtaining both range images and gradation images. For example, by adding two types of light-receiving signals obtained by distributing the charges of photoelectric conversion elements at high speed (light-receiving signals for each tap) on a pixel-by-pixel basis, a gradation signal can be obtained for each pixel.

At this time, to obtain a range image, it is necessary to repeatedly cause a light-emitting unit, which emits light for obtaining reflected light from an object, to emit the light at a relatively high frequency. On the other hand, such repeated light emission is not necessary to obtain a gradation image. Conversely, repeatedly emitting light for finding a range adds periods in which the light emission is off, which makes it difficult to improve the framerate by that amount and is therefore undesirable.

Having been achieved in light of the above-described circumstances, an object of the present technique is to ensure that images are obtained in a manner appropriate for the application, for a sensor unit configured to be capable of light reception operations compatible with an indirect ToF method.

### Solution to Problem

A control device according to the present technique includes a control unit that performs switching control among at least two types of light emission patterns of a light-emitting unit in a sensing module, the sensing module including the light-emitting unit and a sensor unit configured to be capable of a light reception operation compatible with an indirect ToF method for light emitted from the light-emitting unit and reflected by an object.

“ToF” is an acronym for Time of Flight. In addition to obtaining a range image using the indirect ToF method, the sensor unit compatible with the indirect ToF method can be configured to obtain a gradation image of light in the light emission wavelength band of the light-emitting unit, such as an Infrared (IR) image. As described above, the light emission pattern of the light-emitting unit can be switched, which makes it possible to switch to a light emission pattern suited to the application of the sensor unit, such as switching between a light emission pattern for obtaining a range image and a light emission pattern for obtaining a gradation image, or switching to a light emission pattern according to the processing type of image use processing performed using the image obtained by the sensor unit, for example.

A control method according to the present technique includes performing switching control among at least two types of light emission patterns of a light-emitting unit in a sensing module, the sensing module including the light-emitting unit and a sensor unit configured to be capable of a light reception operation compatible with an indirect ToF method for light emitted from the light-emitting unit and reflected by an object.

According to such a control method, the same operations as those of the control device according to the present technique described above can be achieved.

Additionally, another control device according to the present technique includes a control unit configured to perform switching control of a light emission pattern of a light-emitting unit in a sensing module including the light-emitting unit and a sensor unit that receives light emitted from the light-emitting unit and reflected by an object; and as the switching control among the light emission patterns for each of images when obtaining a plurality of images to be composited, the control unit performs control such that an amount of light received by the sensor unit per frame is changed for each of the images.

As a result, a High Dynamic Range (HDR) image can be generated in a system that performs image sensing using a sensing module that includes a light-emitting unit and a sensor unit that receives light emitted from the light-emitting unit and reflected by an object.

### BRIEF DESCRIPTION OF DRAWINGS

FIG. 1 is a block diagram illustrating an example of the configuration of a control system configured including a control device, as an embodiment.

FIG. 2 is a diagram illustrating an example of the arrangement and field of view of a sensor device in an embodiment.

FIG. 3 is a block diagram illustrating an example of the internal configuration of a sensor device in an embodiment.

FIG. 4 is a diagram illustrating an example of the specific arrangement of a light-emitting unit and a sensor unit in a sensing module of an embodiment.

FIG. 5 is a block diagram illustrating an example of the internal circuit configuration of the sensor unit in an embodiment.

FIG. 6 is an equivalent circuit diagram of a pixel of the sensor unit in an embodiment.

FIG. 7 is a block diagram illustrating an example of the configuration of an information processing device as an embodiment.

FIG. 8 is a flowchart illustrating processing corresponding to a first control level in an embodiment.

FIG. 9 is a flowchart illustrating processing corresponding to a second control level in an embodiment.

FIG. 10 is a flowchart illustrating processing pertaining to switching control of a light emission pattern according to a processing type of image use processing.

FIG. 11 is a diagram illustrating an example of a light emission pattern corresponding to a case of obtaining a gradation image in the sensor device.

FIG. 12 is a diagram illustrating a relationship between a light emission pattern and a charge distribution operation when obtaining a gradation image in a sensor device.

FIG. 13 is a diagram illustrating an example of a light emission pattern corresponding to a case of obtaining a range image in the sensor device.

FIG. 14 is a diagram illustrating a relationship between a period of repeated light emission and a charge distribution operation corresponding to when obtaining a range image.

FIG. 15 is an explanatory diagram illustrating a light emission pattern for obtaining an HDR image for a gradation image.

FIG. 16 is an explanatory diagram illustrating a light emission pattern for obtaining an HDR image for a range image.

FIG. 17 is an explanatory diagram illustrating a light emission pattern as a variation pertaining to HDR compositing.

### DESCRIPTION OF EMBODIMENTS

Hereinafter, embodiments according to the present technique will be described in the following order with reference to the accompanying drawings.
<1. Overview of Configuration of Control System>
<2. Configuration of Sensor Device>
<3. Configuration of Information Processing Device>
<4. In-Vehicle Monitoring Processing>
<5. Light Emission Control as Embodiment>
(5-1. Light Emission Control According to Processing Type)
(5-2. HDR)
<6. Variation>
<7. Summary of Embodiment>
<8. Present Technique>

### 1. Overview of Configuration of Control System

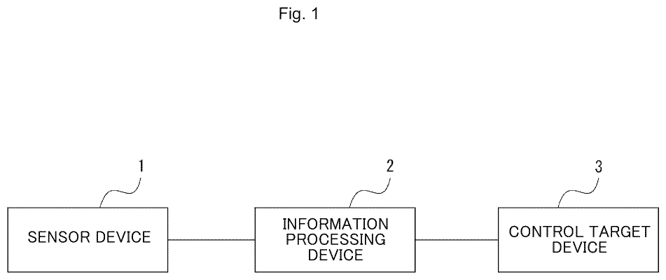

FIG. 1 is a block diagram illustrating an example of the configuration of a control system configured including a control device, as an embodiment of the present technique.

As illustrated, the control system of the embodiment is constituted by a sensor device 1, an information processing device 2, and a control target device 3. The control system in this example is configured as an in-vehicle system that performs control in accordance with in-vehicle monitoring. Specifically, control according to in-vehicle monitoring is performed by the information processing device 2 controlling the control target device 3 based on detection information from the sensor device 1.

The sensor device 1 is a device provided with a sensing module (a sensing module SM, described later) which includes a light-emitting unit and a sensor unit configured to be capable of light reception operations compliant with an indirect Time of Flight (ToF) method for light emitted from the light-emitting unit and reflected by an object.

The sensor device 1 can perform rangefinding using the indirect ToF method in units of pixels, and can therefore obtain a range image. Here, “range image” refers to an image that indicates distance information for each pixel.

In the sensor device 1, the light reception intensity can be detected for each pixel, and a gradation image can therefore also be obtained. “Gradation image” refers to an image that indicates light reception intensity information for each pixel. In this example, the light-emitting unit emits IR (Infrared) light, and thus an IR image showing the light reception intensity of the IR light can be obtained as the gradation image.

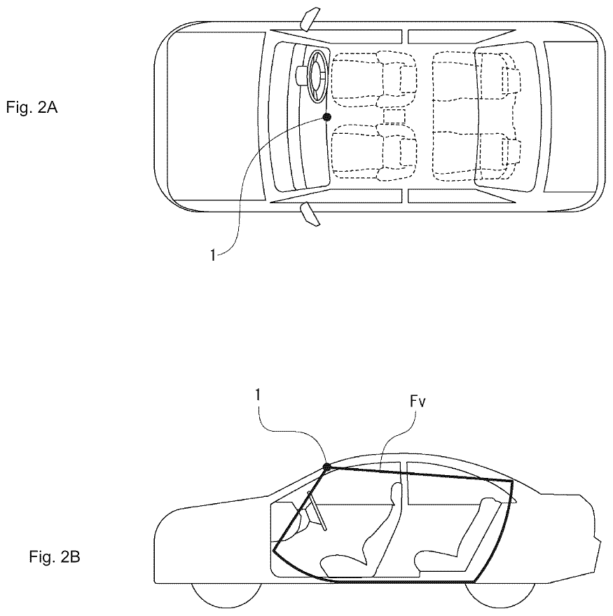

FIG. 2 is a diagram illustrating an example of the arrangement and field of view Fv of the sensor device 1, where FIG. 2A is a top view of a vehicle in which the control system is installed, and FIG. 2B is a right side view of the vehicle.

The sensor device 1 is disposed in a position where the vehicle cabin can be captured in the field of view Fv for monitoring the interior of the vehicle cabin. In this example, the sensor device 1 is disposed within the vehicle cabin, in a position corresponding to a horizontal center of the top of the windshield, and the steering wheel, as well as left and right front seats (the driver's seat and the passenger seat) and left and right rear seats, are included within the field of view Fv (see FIG. 2B).

Note that the control system can also be configured having a plurality of sensor devices 1 for in-vehicle monitoring, such as a sensor device 1 for the front seats and a sensor device 1 for the rear seats.

In FIG. 1, the information processing device 2 is configured including a computer device, and performs processing using the images obtained by the sensor device 1 (called “image use processing” hereinafter). Processing for recognizing a monitoring target based on range images and gradation images obtained by the sensor device 1 and the like can be given as an example of the image use processing. The types of image use processing in this example will be described later.

In addition, the information processing device 2 performs processing for controlling the control target device 3 based on a recognition result when the recognition processing for a monitoring target is performed as the image use processing. Various types of in-vehicle Electric Control Units (ECUs) for controlling various operations of the vehicle, such as acceleration and deceleration of the vehicle, steering, presentation of various types information to occupants, and the like, can be given as examples of the control target device 3.

For example, it is conceivable that the information processing device 2 recognizes the state of the driver based on the images obtained by the sensor device 1, and performs control to cause the vehicle to decelerate when the state of the driver is a predetermined state (e.g., an anomalous state). In that case, the control target device 3 is an ECU that performs control to cause the vehicle to decelerate (e.g., a brake ECU or the like). Alternatively, it is also conceivable to present information to an occupant, such as warning information, when the driver is in a predetermined state, and in that case, the control target device 3 is an ECU that performs control pertaining to information presentation (e.g., a meter ECU or the like).

### 2. Configuration of Sensor Device

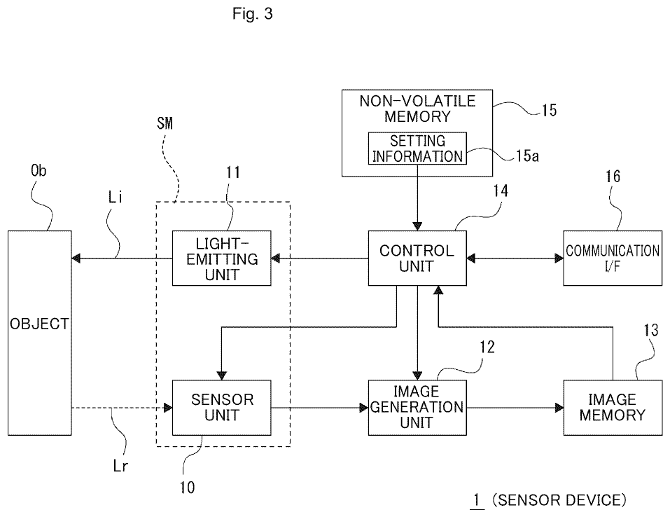

The configuration of the sensor device 1 will be described with reference to FIGS. 3 to 6.

FIG. 3 is a block diagram illustrating an example of the internal configuration of the sensor device 1.

The sensor device 1 includes a sensing module SM configured having a light-emitting unit 11 and a sensor unit 10, and further includes an image generation unit 12, an image memory 13, a control unit 14, a non-volatile memory 15, and a communication interface (I/F).

As described above, the sensor device 1 is capable of rangefinding using the indirect ToF method, and the indirect ToF method is a rangefinding method that calculates a distance to an object Ob based on a phase difference between irradiated light Li irradiated toward the object Ob and reflected light Lr obtained when the irradiated light Li is reflected by the object Ob.

The light-emitting unit 11 has one or more light-emitting elements as light sources, and emits the irradiated light Li toward the object Ob. In this example, the light-emitting unit 11 emits IR light having a wavelength ranging from 750 nm to 1400 nm, for example, as the irradiated light Li.

The sensor unit 10 receives the reflected light Lr. Specifically, a light reception operation of receiving the reflected light Lr is performed such that the phase difference between the reflected light Lr and the irradiated light Li can be detected.

As will be described later, the sensor unit 10 in this example includes a pixel array unit 111, in which a plurality of pixels Px are arranged two-dimensionally. Each pixel Px is configured including a photoelectric conversion element (photodiode PD) as well as a first transfer gate element (transfer transistor TG-A) and a second transfer gate element (transfer transistor TG-B) for transferring charges accumulated in the photoelectric conversion element, with light reception operations compatible with the indirect ToF method being performed for each pixel Px.

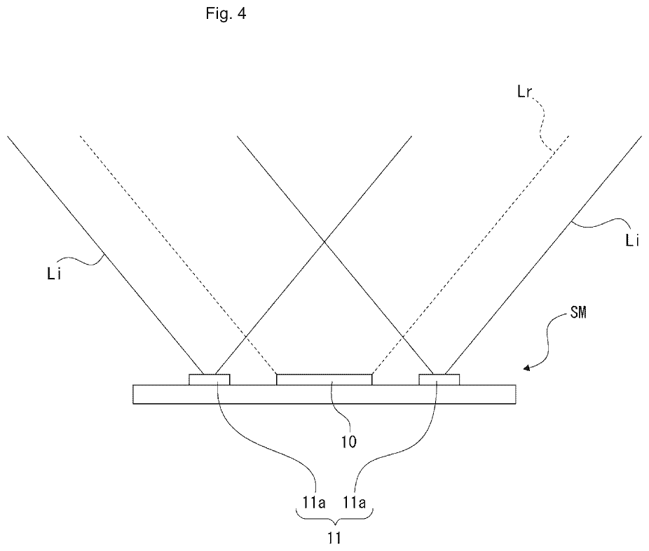

FIG. 4 is a diagram illustrating an example of the specific arrangement of the light-emitting unit 11 and the sensor unit 10 in the sensing module SM.

As illustrated here, in the sensing module SM in this example, the light-emitting unit 11 has two light-emitting elements 11a. In this example, a Vertical Cavity Surface Emitting Laser (VCSEL) is used for these light-emitting elements 11a.

The two light-emitting elements 11a are disposed spaced apart in a plane parallel to a light-emitting surface, and the sensor unit 10 is disposed in a central position that is between the two light-emitting elements 11a.

Providing a plurality of the light-emitting elements 11a makes it possible to expand the irradiation range of the irradiated light Li, i.e., expand the range over which the reflected light Lr can be obtained, which in turn makes it possible to expand the range over which rangefinding is possible.

In FIG. 3, the control unit 14 controls the operations for emitting the irradiated light Li by the light-emitting unit 11. In an indirect ToF method, intensity-modulated light is used as the irradiated light Li such that the intensity changes over a predetermined cycle. Specifically, in this example, pulsed light is repeatedly emitted at a predetermined cycle as the irradiated light Li. The light-emission cycle of such pulsed light will be referred to as a “light-emission cycle Cl” hereinafter. A period between the timings at which the pulsed light starts being emitted when the pulsed light is repeatedly emitted in the light-emission cycle Cl will be referred to as a “single modulation period Pm” or simply a “modulation period Pm”.

The control unit 14 controls the light emission operations of the light-emitting unit 11 such that the irradiated light Li is emitted only during a predetermined light emission period for each modulation period Pm.

In the indirect ToF method, the light-emission cycle Cl is assumed to be relatively fast, e.g., on the order of several tens to several hundreds of MHz.

Here, as is known, in the indirect ToF method, the signal charges accumulated in the photoelectric conversion elements of the pixels Px of the sensor unit 10 are distributed between two floating diffusions (FDs) by the first transfer gate element and the second transfer gate element, which are turned on alternately. In this case, the cycle at which the first transfer gate element and the second transfer gate element are alternately turned on is the same cycle as the light-emission cycle Cl of the light-emitting unit 11. In other words, the first transfer gate element and the second transfer gate element are each turned on once in each modulation period Pm, and the distribution of the signal charges as described above to the two floating diffusions is repeated for each modulation period Pm.

For example, the transfer transistor TG-A serving as the first transfer gate element is turned on in the light emission period of the irradiated light Li in the modulation period Pm, and the transfer transistor TG-B serving as the second transfer gate element is turned on in a non-light-emission period of the irradiated light Li in the modulation period Pm.

In addition, when applying IQ modulation (I: In-phase (in-phase component), Q: Quadrature (quadrature component)) in the rangefinding operations, the transfer transistor TG-A may be turned on/off in a cycle in which the phase is shifted by 90 degrees relative to the light-emission cycle of the irradiated light Li, and the transfer transistor TG-B may be turned on/off in a cycle in which the phase is shifted by 270 degrees relative to the cycle of the irradiated light Li.

As mentioned above, the light-emission cycle Cl is relatively fast, and thus the signal charges accumulated in each floating diffusion are relatively minute from the single distribution performed using the first and second transfer gate elements as described above. For this reason, with the indirect ToF method, the emission of the irradiated light Li is repeated several thousands to several tens of thousands of times per instance of rangefinding (i.e., when obtaining a single range image), and in the sensor unit 10, the distribution of the signal charges to each floating diffusion using the first and second transfer gate elements as described above is repeated while the irradiated light Li is repeatedly emitted.

As can be understood from the foregoing descriptions, in the sensor unit 10, the first transfer gate element and the second transfer gate element are driven at timings based on the light-emission cycle of the irradiated light Li for each pixel Px. For this reason, the control unit 14 controls the light reception operations by the sensor unit 10 and the light emission operations by the light-emitting unit 11 based on the common clock CLK.

The non-volatile memory 15 is connected to the control unit 14. The non-volatile memory 15 is constituted by, for example, an Electrically Erasable Programmable Read Only Memory (EEPROM), and setting information 15a that specifies operating modes for the light emission operations of the light-emitting unit 11 and the light reception operations of the sensor unit 10 as described above is stored therein.

As will be described later, in the sensor device 1, the operating modes for the light emission operations of the light-emitting unit 11 and the light reception operations of the sensor unit 10 can be selected as desired from among operating modes determined in advance. Operation setting information for the light-emitting unit 11 and the sensor unit 10 for implementing the operating modes is stored in the non-volatile memory 15 as the setting information 15a for each of the operating modes.

In other words, the control unit 14 can cause the light-emitting unit 11 and the sensor unit 10 to operate in the selected operating mode by controlling the operations of the light-emitting unit 11 and the sensor unit 10 according to any of the operation setting information selected from the operation setting information stored as the setting information 15a.

Specific examples of the setting information 15a will be given later.

The communication I/F 16 is connected to the control unit 14. The communication I/F 16 is an interface unit for performing wired or wireless communication with an external device, and particularly with the information processing device 2, in this example.

The control unit 14 can communicate various types of data with the information processing device 2 (a CPU 21, which will be described later) via the communication I/F 16.

The image generation unit 12 generates a range image, a gradation image, and the like based on the charge signals accumulated in each floating diffusion through the aforementioned distribution operations performed in the sensor unit 10.

By performing predetermined computations using the indirect ToF method for the charge signals accumulated in each floating diffusion, a distance (a distance to the object) can be calculated for each pixel Px, and a range image indicating the distance information for each pixel Px can be obtained. Note that a publicly-known method can be used to calculate the distance information using the indirect ToF method based on two types of detection signals (detection signals for each floating diffusion) for each pixel Px, and the method will therefore not be described here. In addition, by adding the charge signals accumulated in each floating diffusion, information indicating the light reception intensity of the reflected light Lr can be obtained for each pixel Px, and a gradation image indicating the light reception intensity for each pixel Px can be obtained.

The image memory 13 is a storage device such as, for example, a flash memory, a solid state drive (SSD), or a hard disk drive (HDD), and is used to store the range images and gradation images generated by the image generation unit 12. The control unit 14 can send the range images and gradation images stored in the image memory 13 to the information processing device 2 via the communication I/F 16.

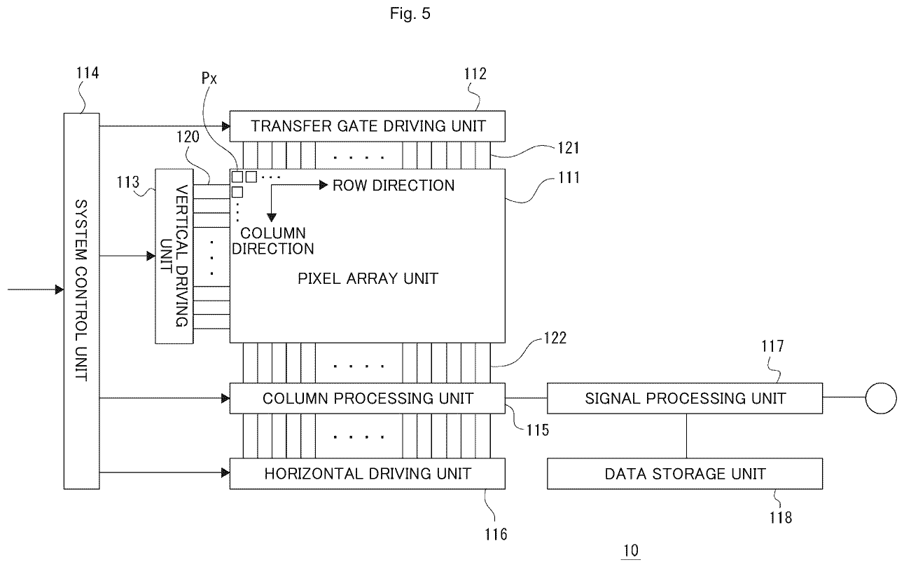

FIG. 5 is a block diagram illustrating an example of the internal circuit configuration of the sensor unit 10.

As illustrated here, the sensor unit 10 includes the pixel array unit 111, a transfer gate driving unit 112, a vertical driving unit 113, a system control unit 114, a column processing unit 115, a horizontal driving unit 116, a signal processing unit 117, and a data storage unit 118.

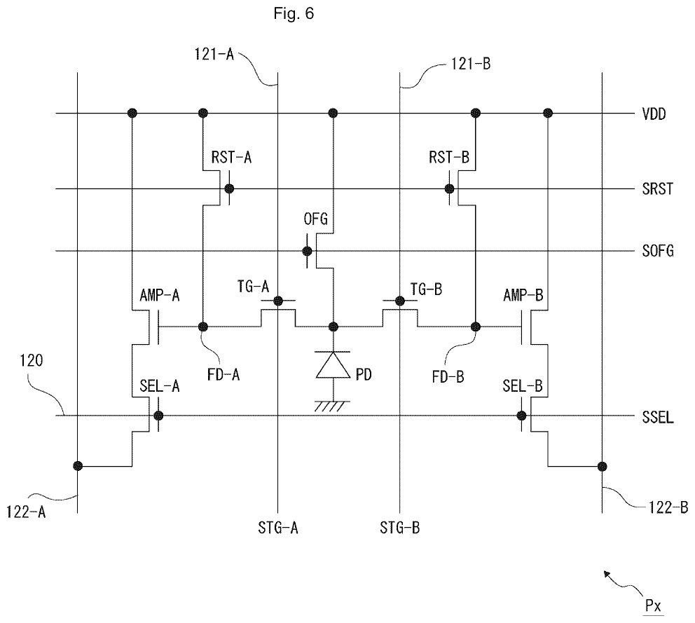

The pixel array unit 111 is configured with the plurality of pixels Px arranged two-dimensionally in a matrix in a row direction and a column direction. Each pixel Px has a photodiode PD serving as a photoelectric conversion element (described later). The pixel Px will be described in detail later with reference to FIG. 6.

Here, the row direction is a direction in which the pixels Px are arranged in the horizontal direction, and the column direction is a direction in which the pixels Px are arranged in the vertical direction. In the figure, the row direction is the horizontal direction, and the column direction is the vertical direction.

In the pixel array unit 111, for a matrix-shaped pixel array, a row drive line 120 is provided along the row direction for each row of pixels, and two gate drive lines 121 and two vertical signal lines 122 are provided along the column direction for each column of pixels. For example, the row drive line 120 transfers a drive signal for driving when reading out a signal from the pixel Px. Note that in FIG. 5, one wire is indicated as the row drive line 120, but the present technique is not limited to one line. One end of the row drive line 120 is connected to an output end of the vertical driving unit 113 corresponding to each row.

The system control unit 114, which is constituted by a timing generator for generating various timing signals and the like, controls the driving of the transfer gate driving unit 112, the vertical driving unit 113, the column processing unit 115, the horizontal driving unit 116, and the like based on the various timing signals generated by the timing generator.

Under the control of the system control unit 114, the transfer gate driving unit 112 drives the transfer gate elements provided two for each pixel Px through the gate drive lines 121 provided two for each column of pixels as described above.

As mentioned above, the two transfer gate elements are turned on alternately for each modulation period Pm. Accordingly, the system control unit 114 supplies the clock CLK input from the control unit 14 illustrated in FIG. 3 to the transfer gate driving unit 112, and the transfer gate driving unit 112 drives the two transfer gate elements based on the clock CLK.

The vertical driving unit 113 is configured as a shift register, an address decoder, or the like, and drives the pixels Px of the pixel array unit 111 all at the same time, in units of rows, or the like. That is, the vertical driving unit 113 constitutes a driving unit that controls the operation of each pixel Px of the pixel array unit 111 along with the system control unit 114, which controls the vertical driving unit 113.

A detection signal output (read out) from each pixel Px in a row of pixels in response to driving control by the vertical driving unit 113, and to be more specific, a signal (a charge signal) based on the signal charge accumulated in each floating diffusion provided two for each pixel Px, is input to the column processing unit 115 through the corresponding vertical signal line 122. The column processing unit 115 performs predetermined signal processing on the detection signal read out from each pixel Px through the vertical signal line 122, and temporarily holds the detected signal after the signal processing. Specifically, the column processing unit 115 performs noise removal processing using Correlated Double Sampling (CDS), Analog to Digital (A/D) conversion processing, and the like as the signal processing.

Here, the two detection signals (the detection signal for each floating diffusion) are read out from each pixel Px once for each predetermined number of times of the repeated emission of the irradiated light Li (each repeated emission of several thousands to several tens of thousands of times, as described above).

Accordingly, the system control unit 114 controls the vertical driving unit 113 based on the clock CLK such that the timing at which the detection signals are read out from each pixel Px is the timing of each predetermined number of times of the repeated emission of the irradiated light Li in this manner.

The horizontal driving unit 116 is constituted by a shift register, an address decoder, and the like, and selects the unit circuits corresponding to each column of pixels of the column processing unit 115 in sequence. Through selective scanning by the horizontal driving unit 116, the detection signals subjected to the signal processing for each unit circuit in the column processing unit 115 are output in sequence.

The signal processing unit 117 has at least an arithmetic processing function, and performs predetermined signal processing on the detection signals output from the column processing unit 115.

The data storage unit 118 temporarily stores data required for signal processing performed by the signal processing unit 117 when performing the signal processing.

FIG. 6 illustrates an equivalent circuit of each of the pixels Px arranged two-dimensionally in the pixel array unit 111.

Each pixel Px includes the photodiode PD serving as a photoelectric conversion element and an overflow (OF) gate transistor OFG. Each pixel Px also includes two each of a transfer transistor TG serving as a transfer gate element, a floating diffusion FD, a reset transistor RST, an amplifying transistor AMP, and a selection transistor SEL.

When distinguishing between the transfer transistors TG, the floating diffusions FD, the reset transistors RST, the amplifying transistors AMP, and the selection transistors SEL, two of each of which are provided in the pixel Px, these elements will be referred to as transfer transistors TG-A and TG-B, floating diffusions FD-A and FD-B, reset transistors RST-A and RST-B, amplifying transistors AMP-A and AMP-B, and selection transistors SEL-A and SEL-B, as illustrated in FIG. 6.

The OF gate transistor OFG, the transfer transistors TG, the reset transistors RST, the amplifying transistors AMP, and the selection transistors SEL are constituted by, for example, N-type MOS transistors.

The OF gate transistor OFG enters a conductive state when an OF gate signal SOFG supplied to the gate is turned on. When the OF gate transistor OFG enters a conductive state, the photodiode PD is clamped to a predetermined reference potential VDD, and the accumulated charge is reset.

Note that the OF gate signal SOFG is supplied from the vertical driving unit 113, for example.

The transfer transistor TG-A enters a conductive state when a transfer drive signal STG-A supplied to the gate is turned on, and the signal charge accumulated in the photodiode PD is transferred to the floating diffusion FD-A. The transfer transistor TG-B enters a conductive state when a transfer drive signal STG-B supplied to the gate is turned on, and the signal charge accumulated in the photodiode PD is transferred to the floating diffusion FD-B.

The transfer drive signals STG-A and STG-B are supplied from the transfer gate driving unit 112 through gate drive lines 121-A and 121-B, respectively, each of which is provided as one of the gate drive lines 121 illustrated in FIG. 5.

The floating diffusions FD-A and FD-B are charge holding units that temporarily hold the charge transferred from the photodiode PD.

The reset transistor RST-A enters a conductive state when a reset signal SRST supplied to the gate is turned on, and the potential of the floating diffusion FD-A is reset to the reference potential VDD. Likewise, the reset transistor RST-B enters a conductive state when a reset signal SRST supplied to the gate is turned on, and the potential of the floating diffusion FD-B is reset to the reference potential VDD. Note that the reset signal SRST is supplied from the vertical driving unit 113, for example.

In the amplifying transistor AMP-A, the source is connected to a vertical signal line 122-A through the selection transistor SEL-A, and the drain is connected to the reference potential VDD (a constant current source), which configures a source follower circuit. In the amplifying transistor AMP-B, the source is connected to a vertical signal line 122-B through the selection transistor SEL-B, and the drain is connected to the reference potential VDD (a constant current source), which configures a source follower circuit.

Here, each of the vertical signal lines 122-A and 122-B is provided as one of the vertical signal lines 122 illustrated in FIG. 5.

The selection transistor SEL-A is connected between the source of the amplifying transistor AMP-A and the vertical signal line 122-A, and enters a conductive state when a selection signal SSEL supplied to the gate is turned on, whereupon the charge held in the floating diffusion FD-A is output to the vertical signal line 122-A through the amplifying transistor AMP-A.

The selection transistor SEL-B is connected between the source of the amplifying transistor AMP-B and the vertical signal line 122-B, and enters a conductive state when the selection signal SSEL supplied to the gate is turned on, whereupon the charge held in the floating diffusion FD-B is output to the vertical signal line 122-B through the amplifying transistor AMP-A.

Note that the selection signal SSEL is supplied from the vertical driving unit 113 through the row drive line 120.

Operations of the pixel Px will be briefly described.

First, before starting the reception of light, a reset operation that resets the charge of the pixel Px is performed on all the pixels. In other words, for example, the OF gate transistor OFG, each reset transistor RST, and each transfer transistor TG are turned on (enter a conductive state), and the accumulated charges of the photodiode PD and each floating diffusion FD are reset.

After the accumulated charge is reset, the light reception operation for rangefinding is started in all the pixels. Here, “light reception operation” refers to a light reception operation performed for a single instance of rangefinding. In other words, during the light reception operation, the operation of alternately turning on the transfer transistors TG-A and TG-B is repeated a predetermined number of times (several thousands to several tens of thousands of times, in this example). The period of the light reception operation performed for such a single instance of rangefinding will be referred to as a “light-receiving period Pr” hereinafter.

In the light-receiving period Pr, in a single modulation period Pm of the light-emitting unit 11, after, for example, the period in which the transfer transistor TG-A is turned on (i.e., the period in which the transfer transistor TG-B is turned off) is continued over the light emission period of the irradiated light Li, the remaining period, i.e., the non-light-emission period of the irradiated light Li, is taken as the period in which the transfer transistor TG-B is turned on (i.e., the period in which the transfer transistor TG-A is turned off). In other words, in the light-receiving period Pr, the operation of distributing the charge in the photodiode PD to the floating diffusions FD-A and FD-B in a single modulation period Pm is repeated a predetermined number of times.

In addition, when the light-receiving period Pr ends, the pixels Px in the pixel array unit 111 are selected line-sequentially. In the selected pixel Px, the selection transistors SEL-A and SEL-B are turned on. As a result, the charge accumulated in the floating diffusion FD-A is output to the column processing unit 115 through the vertical signal line 122-A. Likewise, the charge accumulated in the floating diffusion FD-B is output to the column processing unit 115 through the vertical signal line 122-B.

As described above, one light reception operation ends, and the next light reception operation starting from a reset operation is then executed.

Here, the reflected light Lr received by the pixel Px is delayed from the timing at which the light-emitting unit 11 has emitted the irradiated light Li, according to the distance to the object Ob. The delay time according to the distance to the object Ob changes the distribution ratio of the charges accumulated in the two floating diffusions FD-A and FD-B, and it is therefore possible to obtain the distance to the object Ob from the distribution ratio of the charges accumulated in the two floating diffusions FD-A and FD-B.

Here, the foregoing has described an example of a case where what is known as a “two-phase method” is used for rangefinding through the indirect ToF method. In other words, an example has been described in which the distance is calculated from two types of light-receiving signals (the charge signals accumulated in the floating diffusions FD-A and FD-B, respectively) obtained by distributing the charges using transfer drive signals STG having phase differences of 0 degrees and 180 degrees relative to the light-emitting signal.

However, what is known as a “four-phase method” can also be used for rangefinding using the indirect ToF method. The four-phase method performs the rangefinding operation based on the above-mentioned IQ modulation, and uses not only light-receiving signals having phase differences of 0 degrees and 180 degrees relative to the light-emitting signal, but also light-receiving signals having phase differences of 90 degrees and 270 degrees.

In this case, in the light-receiving period Pr, the operations of distributing the charges to the floating diffusions FD-A and FD-B using the transfer drive signal STG-A having a phase difference of 0 degrees relative to the light-emitting signal and the transfer drive signal STG-B having a phase difference of 180 degrees are performed to obtain the light-receiving signals having phase differences of 0 degrees and 180 degrees, as described above. Furthermore, operations of distributing the charges to the floating diffusions FD-A and FD-B using the transfer drive signal STG-A having a phase difference of 90 degrees relative to the light-emitting signal and the transfer drive signal STG-B having a phase difference of 270 degrees are performed to obtain light-receiving signals having phase differences of 90 degrees and 270 degrees.

Rangefinding operations using the four-phase method, performed using the four types of light-receiving signals, namely, 0 degrees, 180 degrees, 90 degrees, and 270 degrees, are publicly known, and will therefore not be described in detail here.

### 3. Configuration of Information Processing Device

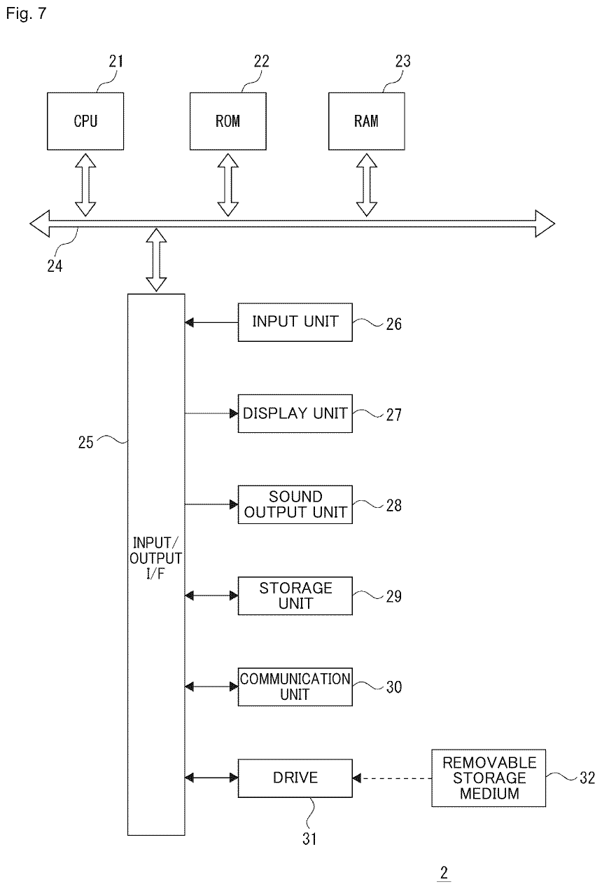

FIG. 7 is a block diagram illustrating an example of the configuration of the information processing device 2.

As illustrated in FIG. 7, the information processing device 2 includes the Central Processing Unit (CPU) 21 and a Read Only Memory (ROM). The CPU 21 executes various types of processing according to programs stored in a ROM 22, a storage unit 29 (described later), and the like, and loaded into a RAM 23.

Data necessary for the CPU 21 to execute the various types of processing is stored as appropriate in the RAM 23.

The CPU 21, the ROM 22, and the RAM 23 are connected to each other by a bus 24. An input/output interface (I/F) 25 is also connected to the bus 24.

An input unit 26 constituted by an operator or an operation device is connected to the input/output interface 25. For example, various types of operators or operation devices, such as a keyboard, a mouse, keys, a dial, a touch panel, a touch pad, and a remote controller, are conceivable as the input unit 26.

A user operation is detected by the input unit 26, and a signal corresponding to the input operation is interpreted by the CPU 21.

Further, a display unit 27 constituted by a Liquid Crystal Display (LCD), an organic Electro-Luminescence (EL) panel, or the like, and a sound output unit 28 constituted by a speaker or the like, are connected to the input/output interface 25 as one entity or separate entities.

The display unit 27 is a display unit that performs various displays, and is configured of, for example, a display device provided in the housing of the computer device or a separate display device connected to the computer device.

The display unit 27 executes the display of images for various types of image processing, moving images to be processed, and the like in the display screen based on instructions from the CPU 21. The display unit 27 displays various operation menus, icons, and messages, i.e., a Graphical User Interface (GUI), in response to instructions from the CPU 21.

The storage unit 29 constituted by a hard disk, a solid-state memory, or the like, a communication unit 30 constituted by a modem or the like, and so on may be connected to the input/output interface 25.

The communication unit 30 performs communication processing over a transmission path such as the Internet, communication such as wired/wireless communication or bus communication with various types of devices, and the like. In particular, in the present embodiment, data communication between the sensor device 1 and the control target device 3 can be performed via the communication unit 30.

A drive 31 is also connected to the input/output interface 25 as necessary, and a removable storage medium 32 such as a magnetic disk, an optical disk, a magneto-optical disk, or a semiconductor memory is mounted in the drive 31 as appropriate.

The drive 31 can be used to read out data files such as programs used for each instance of processing from the removable storage medium 32. The read-out data files are stored in the storage unit 29, used for various types of processing by the CPU 21, and the like. The computer programs or the like read out from the removable storage medium 32 are installed in the storage unit 29 as necessary.

### 4. In-Vehicle Monitoring Processing

The information processing device 2 performs processing (image use processing) using the images obtained by the sensor device 1 (in-vehicle monitoring images) as processing related to in-vehicle monitoring in a vehicle in which the control system illustrated in FIG. 1 is installed.

For this image use processing, processing pertaining to the recognition of objects present in the vehicle, such as the driver, is performed. Specifically, in this example, the following processing can be performed as the image use processing.
user authentication processing
posture recognition processing
attention detection processing
item forgotten in seat detection processing

The user recognition processing is processing for authenticating the driver as the actual user of the vehicle. This is performed as facial authentication, iris authentication, or the like, for example.

The posture recognition processing is processing for recognizing the posture (body posture) of an occupant such as the driver.

The attention detection processing is processing for detecting how much attention the driver is paying to driving. For example, if the driver is detected as being drowsy or having a decreased level of consciousness due to illness or the like, a low value as a level of attention is detected according to the degree thereof.

The item forgotten in seat detection processing is processing executed when an occupant exits the vehicle, and is processing for detecting whether there is a forgotten item in a seat of the vehicle.

Each of these instances of image use processing is executed at an appropriate timing within a series of periods of time between when an occupant, such as a driver, enters the vehicle and when the occupant exits the vehicle after a state in which the vehicle has been traveling.

In addition, if the levels of vehicle control performed in response to in-vehicle monitoring (called “control levels” hereinafter) are different, the combinations of the processing executed in the image use processing may be different. For example, in a given control level (a first control level), only three of the above four types of image use processing are performed, namely user authentication processing, posture recognition processing, and item forgotten in seat detection processing, whereas in another control level (a second control level), all of the above four types of image use processing are performed.

Specific flows of processing performed by the information processing device 2 will be described hereinafter for each of these control levels.

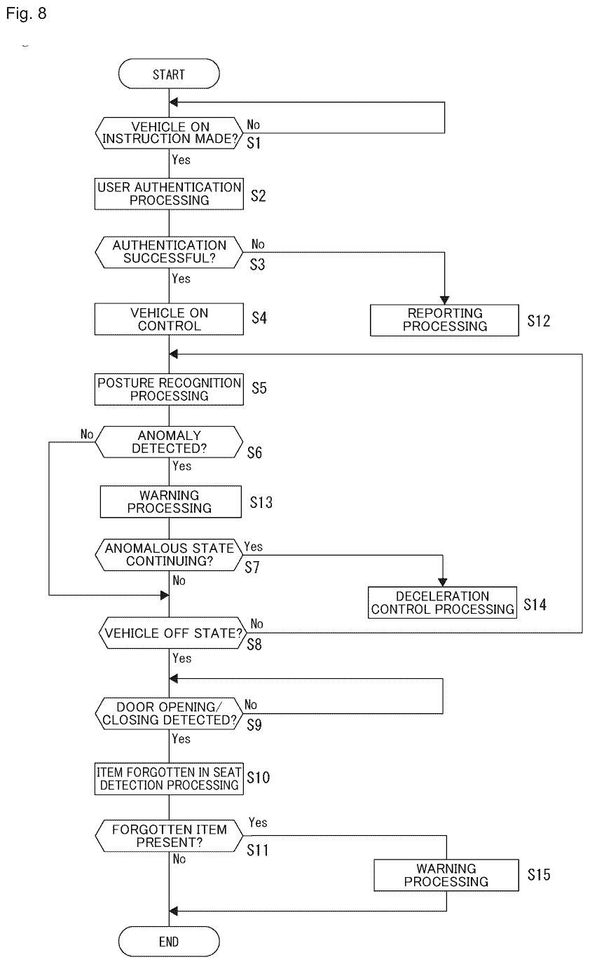

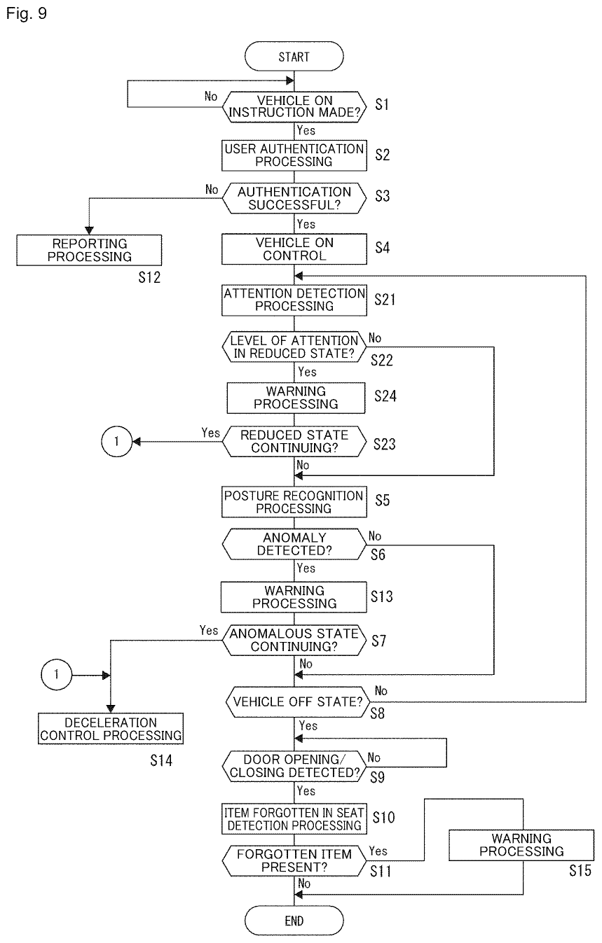

FIG. 8 is a flowchart illustrating processing corresponding to the first control level. The processing illustrated in FIG. 8, as well as in FIG. 9 (described later), is executed by the CPU 21 of the information processing device 2. Note that when the processing illustrated in FIGS. 8 and 9 starts, it is assumed that at least an occupant acting as the driver is already in the vehicle.

In FIG. 8, in step S1, the CPU 21 stands by for the occupant to make a vehicle-on instruction. “Vehicle-on instruction” here refers to an instruction to put the vehicle into a running state. Here, “running state” means, for example, a state in which the engine is turned on, in the case of an engine vehicle, and a state in which the control system of the vehicle is running, in the case of a hybrid vehicle or an electric vehicle. For example, operating a start button provided in the vehicle cabin corresponds to the vehicle-on instruction described here.

If the vehicle-on instruction is made in step S1, the CPU 21 executes the user authentication processing in step S2. The user authentication processing is performed as facial authentication processing or iris authentication processing based on the images obtained by the sensor device 1.

In this example, the user authentication processing may be performed using the gradation image obtained by the sensor device 1, or using the range image.

In step S3, which follows step S2, the CPU 21 determines whether the authentication is successful. In other words, it is determined, based on the result of the user authentication processing in step S2, whether the driver has been recognized as the user, i.e., whether the authentication is successful. In the user authentication processing in this example, the processing is performed based on images from a plurality of frames, instead of based on the image from a single frame. Specifically, in this example, if, for example, the driver is recognized as the user in at least one frame out of five frames, a determination result indicating the authentication is successful is obtained, whereas if the driver is not recognized as the user in all frames, a determination result indicating that the authentication is unsuccessful is obtained.

If the authentication is not successful, the CPU 21 performs reporting processing of step S12. In other words, processing for transmitting information indicating that the authentication has failed to a predetermined external device, such as a predetermined server device (e.g., the server device of a security center), is performed.

On the other hand, if the authentication is successful, the CPU 21 moves to step S4 and performs vehicle-on control. In other words, control is performed to put the vehicle in an on state.

Posture recognition processing (S5) and anomaly detection determination (S6) based on the result of the posture recognition processing are performed during the period from when the vehicle enters the on state to when the vehicle enters an off state, and the processing branches based on the result of the anomaly detection determination.

Specifically, the CPU 21 executes the posture recognition processing of step S5 in response to the vehicle-on control of step S4 being executed. In other words, processing for recognizing the posture of the occupant acting as the driver is performed based on the range image obtained by the sensor device 1. In this posture recognition processing, for example, each part of the driver (e.g., the head, shoulders, arms, hands, torso, and the like) is recognized from the range image, and the posture of the driver is recognized from the positional relationships between the recognized parts.

In step S6, which follows step S5, the CPU 21 makes an anomaly detection determination. In other words, whether the driver is in an anomalous state is determined based on posture information of the driver recognized in the posture recognition processing of step S5. For example, whether the posture of the driver matches a posture which is a predetermined anomalous posture is determined.

In step S6, in this example, an anomaly is not determined immediately in response to only one frame of the image determined to be anomalous, but instead, a determination result indicating an anomaly is obtained when the anomalous state is determined to have continued for a set period of time. Here, the set period of time is assumed to be 1/12 s (seconds), for example. This corresponds to 5 frames' worth of time when the framerate of the image input from the sensor device 1 is 60 fps.

If it is determined that the driver is in an anomalous state, the CPU 21 moves to step S13 and performs warning processing. The warning processing is for making a notification that the driver is in an anomalous state, e.g., processing for outputting a predetermined sound from a speaker provided in the vehicle (e.g., the aforementioned sound output unit 28), processing for displaying predetermined information in a display unit (e.g., the aforementioned display unit 27), or the like.

The CPU 21 performs anomaly state continuation determination processing in step S7 in response to the warning processing of step S13 being executed. In other words, whether the duration of the anomalous state since the anomalous state was detected in step S6 is greater than or equal to a predetermined length of time is determined.

Here, the predetermined length of time is set to ½ s, for example. This corresponds to 30 frames' worth of time when the framerate of the image from the sensor device 1 is 60 fps.

If in step S7 the anomalous state is determined to have continued for greater than or equal to the predetermined length of time, the CPU 21 executes deceleration control processing of step S14. In other words, control is performed to cause the vehicle to decelerate.

On the other hand, if in step S7 the anomalous state is determined not to have continued for greater than or equal to the predetermined length of time, the CPU 21 moves the processing to step S8.

The CPU 21 also moves the processing to step S8 when it is determined in step S6 that the driver is not in an anomalous state.

In step S8, the CPU 21 determines whether the vehicle is in an off state. In other words, whether the vehicle has transitioned to the off state is determined, such as in response to an operation to put the vehicle in the off state being performed.

If the vehicle is not in the off state, the CPU 21 returns to the posture recognition processing of step S5 described earlier. Accordingly, the posture recognition processing (S5) and the anomaly detection determination (S6) based on the result of the posture recognition processing are performed during the period from when the vehicle enters the on state to when the vehicle enters the off state, and warning processing, deceleration control, and the like are performed according to the duration of the anomaly when an anomaly is determined.

If in step S8 the vehicle is determined to be in the off state, the CPU 21 executes processing pertaining to the detection of a forgotten item, indicated in step S9 and on.

Specifically, in step S9, the CPU 21 stands by until a door opening/closing is detected. In other words, the CPU 21 stands by until a door of the vehicle, which has been open, is detected as having closed.

The CPU 21 executes the item forgotten in seat detection processing in step S10 in response to detecting the door opening/closing. In other words, image analysis processing is performed on the gradation image obtained by the sensor device 1 to detect a forgotten item on a seat, and more specifically, a specific object such as a bag, a baby, or the like.

In step S11, which follows step S10, the CPU 21 determines whether there is a forgotten item. In this example, in the detection processing of step S10, an object is not determined to be a forgotten item immediately in response to the object being detected as a forgotten item for only one frame, but instead, a determination result indicating that a forgotten item is present is obtained when a state in which the forgotten item is detected has continued for a set period of time. Here, the set period of time is assumed to be 1 s (second), for example. In other words, this corresponds to 60 frames' worth of time when the framerate of the image is 60 fps.

If in step S11 a forgotten item is determined to be present, the CPU 21 performs the warning processing of step S15. In other words, processing is performed for outputting information for making a notification that a forgotten item is present, through the speaker, the display unit, or the like provided in the vehicle.

The CPU 21 ends the series of processing illustrated in FIG. 8 in response to the warning processing of step S15 being performed.

The CPU 21 also ends the series of processing illustrated in FIG. 8 when no forgotten item is determined to be present in step S11.

FIG. 9 is a flowchart illustrating processing corresponding to the second control level. Note that in FIG. 9, processing that is the same as the processing already described with reference to FIG. 8 will be given the same step numbers, and will not be described in detail.

The difference from the first control level illustrated in FIG. 8 is that both the posture detection processing and attention detection processing are performed after the vehicle enters the on state.

Specifically, in this case, the CPU 21 performs the attention detection processing of step S21 in response to the vehicle-on control of step S4 being executed. In other words, image analysis processing is performed on the gradation image obtained by the sensor device 1 to detect the level of attention of the driver. For example, in the attention detection processing, the level of attention is detected from the facial expression of the driver's face, disparity between the eyes, identifying whether the eyes are open or closed, and the like.

In step S22, which follows step S21, the CPU 21 determines whether the level of attention is in a reduced state. This determination is made based on a result of determining whether the level of attention detected in step S21 is less than or equal to a predetermined threshold. However, in this example, the level of attention is not determined to be in a reduced state immediately in response to the level of attention being determined to be less than or equal to the predetermined threshold, but instead, a determination result indicating that the level of attention is in a reduced state is obtained when a state in which the level of attention is less than or equal to the threshold has continued for a set period of time. Here, the set period of time is assumed to be 1/20 s (seconds), for example. This corresponds to 3 frames' worth of time when the framerate is 60 fps.

If in step S22 the level of attention of the driver is determined to be in a reduced state, the CPU 21 performs the warning processing of step S24. The warning processing is for making a notification to other occupants that the level of attention of the driver is in a reduced state, e.g., processing for outputting a predetermined sound from a speaker provided in the vehicle, processing for displaying predetermined information in a display unit provided in the vehicle, or the like.

On the other hand, if in step S22 the level of attention of the driver is determined not to be in a reduced state, the CPU 21 moves to step S23 and determines whether the reduced state is continuing. In other words, whether the duration of the reduced state of the level of attention since the level of attention was detected as being in a reduced state in step S22 is greater than or equal to a predetermined length of time is determined.

Here, the predetermined length of time is set to ¼ s (15 frames, when the framerate is 60 fps), for example.

If in step S23 the reduced state of the level of attention is determined to have continued for greater than or equal to the predetermined length of time, the CPU 21 executes deceleration control processing of step S14.

On the other hand, if the reduced state of the level of attention is determined not to have continued for greater than or equal to the predetermined length of time, the CPU 21 moves the processing to the posture recognition processing of step S5. If no anomaly is detected as a result of the posture recognition processing, the CPU 21 moves to step S8, determines whether the vehicle is in the off state, and if the vehicle is not in the off state, returns to the attention detection processing of step S21.

Accordingly, at the second control level, both the posture recognition processing and the attention detection processing are performed until the vehicle enters the off state after entering the on state, and the warning processing, deceleration control of the vehicle, and the like are performed according to the results of the processing.

Although the foregoing describes specific examples of time conditions for executing the warning processing, deceleration control, and the like in response to an anomaly detected for the driver, the time conditions described here are merely examples, and it goes without saying that other conditions can be set.

Here, in addition to the user authentication processing, posture recognition processing, attention detection processing, and item forgotten in seat detection processing described above, it is also conceivable to perform emotion estimation processing for estimating the emotional state of an occupant, such as the driver, as the image use processing using images obtained by the sensor device 1, in order to provide a comfortable in-vehicle space, for example.

In this emotion estimation processing, the facial expression of the occupant is detected from, for example, the range image obtained by the sensor device 1, and the occupant's emotional state is estimated based on the result of detecting the facial expression. A comfortable interior space is provided by, for example, controlling the air conditioning in the vehicle cabin in accordance with the estimated emotional state.

### 5. Light Emission Control as Embodiment

### (5-1. Light Emission Control According to Processing Type)

As can be understood from the foregoing descriptions, in the present embodiment, user authentication processing, posture recognition processing, attention detection processing, and item forgotten in seat detection processing (as well as emotion estimation processing) may be performed as the image use processing performed using images obtained by the sensor device 1.

In the present embodiment, the information processing device 2 performs switching control of the light emission pattern of the light-emitting unit 11 in the sensor device 1 according to the processing types of the image use processing.

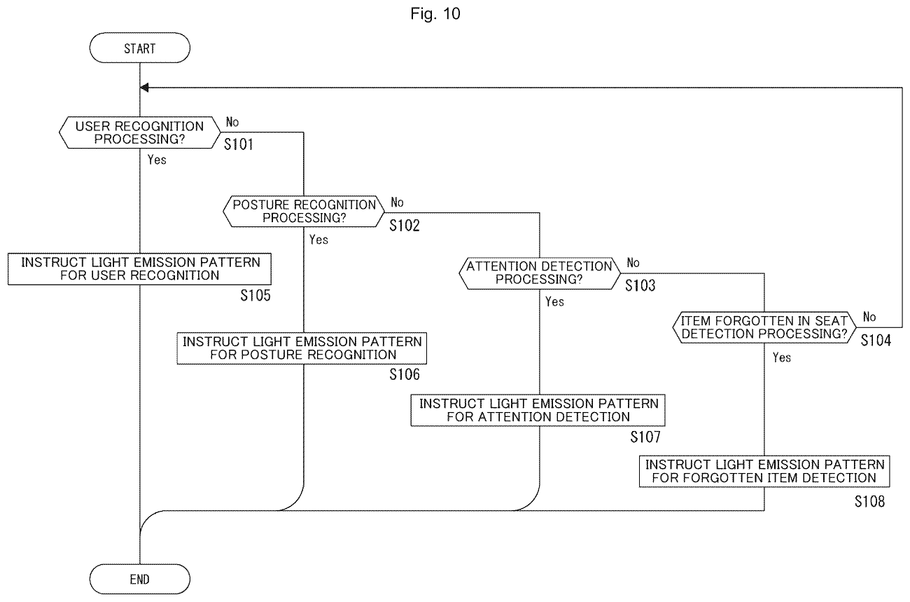

FIG. 10 is a flowchart illustrating processing pertaining to the switching control of the light emission pattern according to the processing type of the image use processing.

The CPU 21 of the information processing device 2 executes the processing illustrated in FIG. 10 in parallel with the processing illustrated in FIGS. 8 and 9. Specifically, the CPU 21 in this example executes the processing illustrated in FIG. 10 repeatedly while the processing of FIGS. 8 and 9 is being executed.

As illustrated, the CPU 21 determines the processing type of the image use processing to be executed through the processing of steps S101, S102, S103, and S104. Specifically, whether the image use processing is the user authentication processing, the posture recognition processing, the attention detection processing, or the item forgotten in seat detection processing is determined.

If in step S101 the processing is determined to be the user authentication processing, in step S105, the CPU 21 issues a user authentication light emission pattern instruction. In other words, an instruction for causing the light-emitting unit 11 to emit light using a light emission pattern corresponding to the user authentication processing is issued to the sensor device 1, and more specifically, to the control unit 14.

If in step S102 the processing is determined to be the posture recognition processing, in step S106, the CPU 21 issues an instruction to the control unit 14 to cause the light-emitting unit 11 to emit light using a light emission pattern corresponding to the posture recognition processing as a posture recognition light emission pattern instruction.

In addition, if in step S103 the processing is determined to be the attention detection processing, in step S107, the CPU 21 issues an instruction to the control unit 14 to cause the light-emitting unit 11 to emit light using a light emission pattern corresponding to the attention detection processing as an attention detection light emission pattern instruction.

In addition, if in step S104 the processing is determined to be the item forgotten in seat detection processing, in step S108, the CPU 21 issues an instruction to the control unit 14 to cause the light-emitting unit 11 to emit light using a light emission pattern corresponding to the item forgotten in seat detection processing as a forgotten item detection light emission pattern instruction.

The CPU 21 ends the series of processing illustrated in FIG. 10 in response to the instruction of any of steps S105, S106, S107, and S108 being issued.

The above-described processing makes it possible to cause the light-emitting unit 11 in the sensor device 1 to emit light using a light emission pattern appropriate for the processing type of the image use processing to be executed.

A specific example of the light emission pattern will be described hereinafter.

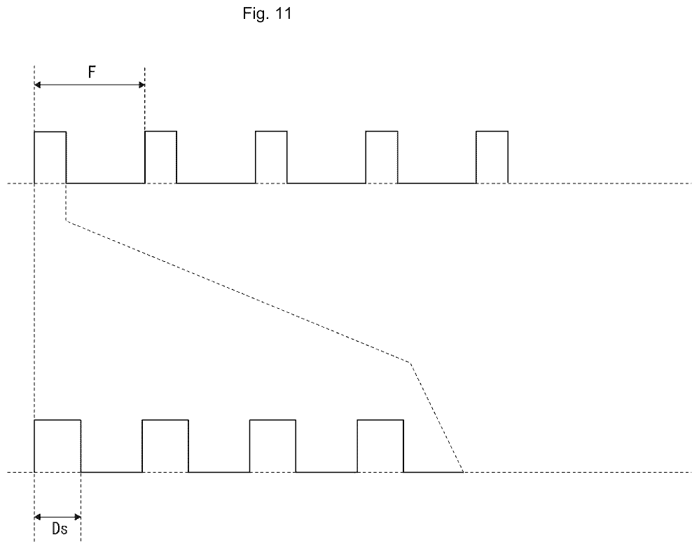

FIG. 11 is a diagram illustrating an example of the light emission pattern corresponding to a case of obtaining a gradation image in the sensor device 1.

In the figure, the letter “F” means one frame period. In the sensor device 1, when obtaining a range image through the indirect ToF method, the light-emitting unit 11 repeatedly emits light at a high-speed cycle such as several tens of MHz to several hundreds of MHz, but when obtaining a gradation image, such high-speed repeated light emission is not necessary.

For this reason, when obtaining the gradation image, the light-emitting unit 11 continuously emits light for a predetermined period of time with the ON duty of a light emission drive signal at 100%.

If light is emitted continuously in this manner by setting the ON duty to 100%, the light emission period used to achieve the same light amount can be made shorter than when repeatedly emitting light for rangefinding. This makes it possible to suppress a drop in the framerate for gradation images.

Here, the sensor device 1 is configured to be capable of rangefinding using the indirect ToF method, and as described earlier, the light reception operation involves a charge distribution operation. Specifically, one unit of the light reception operation is an operation in which the charges are distributed to the floating diffusions FD-A and FD-B, and the charge signals obtained in the floating diffusions FD-A and FD-B as a result of the distribution operation are read out.

In the case of the two-phase method described above, it is sufficient for this unit of the light reception operation to be performed at least once per frame, but in the case of the four-phase method, this unit of the light reception operation is performed four times per frame.

This example will describe the light emission pattern corresponding to a case where the sensor device 1 is configured to be capable of rangefinding using the four-phase method.

Specifically, in this case, the light emission pattern used when obtaining a gradation image is a light emission pattern that continuously emits light in a period Ds four times per frame, as illustrated in the figure. More specifically, the light emission pattern in this case is a light emission pattern in which, in synchronization with an execution cycle of the unit of the light reception operation that is performed four times in single frame period F, light is emitted continuously at an ON duty of 100% throughout the period Ds for each execution period of the unit of the light reception operation.

Here, “period Ds” refers to a light emission period corresponding to a single unit of the light reception operation when emitting light continuously to obtain a gradation image.

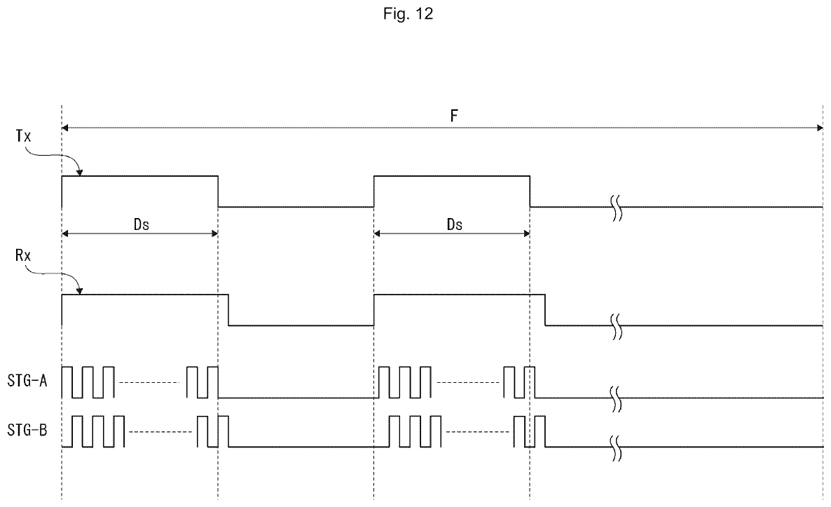

A relationship between the light emission pattern and the charge distribution operation in this case will be described with reference to FIG. 12.

In FIG. 12, the waveform indicated by “Tx” is the waveform of the light emission drive signal of the light-emitting unit 11.

As described above, in this example, as per the four-phase method, light-receiving signals having phase differences of 0 degrees, 90 degrees, 180 degrees, and 270 degrees relative to the light emission drive signal are obtained. For this reason, for example, as illustrated in the figure, in the first continuous light-emission period Ds in one frame period F, the transfer drive signal STG-A having a phase difference of 0 degrees relative to the light emission drive signal and the transfer drive signal STG-B having a phase difference of 180 degrees are used to distribute the charges to the floating diffusions FD-A and FD-B. In the next continuous light-emission period Ds, the transfer drive signal STG-A having a phase difference of 90 degrees relative to the light emission drive signal and the transfer drive signal STG-B having a phase difference of 270 degrees are used to distribute the charges to the floating diffusions FD-A and FD-B.

Although not illustrated, in the third continuous light-emission period Ds, as in the first period Ds, the transfer drive signal STG-A having a phase difference of 0 degrees and the transfer drive signal STG-B having a phase difference of 180 degrees are used to distribute the charges to the floating diffusions FD-A and FD-B, and in the fourth period Ds, as in the second period Ds, the transfer drive signal STG-A having a phase difference of 90 degrees and the transfer drive signal STG-B having a phase difference of 270 degrees are used to distribute the charges to the floating diffusions FD-A and FD-B. In this case, signals at 0 degrees, 90 degrees, 180 degrees, and 270 degrees are obtained twice as a result of the unit of the light reception operation being performed four times in the single frame. In the rangefinding operation using the four-phase method in this case, the distance can be calculated based on these signals. For example, the noise resistance is increased by averaging the corresponding signals at 0 degrees, 90 degrees, 180 degrees, and 270 degrees obtained twice as described above, and then performing the rangefinding operation using the four-phase method.

Note that in the four-phase method, it is sufficient to obtain the signals at 0 degrees, 90 degrees, 180 degrees, and 270 degrees at least once in one frame period F, and as such, it is sufficient for the number of times the light-emitting unit 11 emits light continuously in one frame period F to be at least twice.

In FIG. 12, the waveform indicated by “Rx” is a waveform representing the execution period of the unit of the light reception operation.

With respect to the unit of the light reception operation, the light-receiving period (the ON period of Rx in the figure) is made slightly longer than the light emission period such that the reflected light Lr from the object Ob can be received without leakage.

As described above, in this example, based on the relationship in which the sensor device 1 is configured to perform the unit of the light reception operation as per the four-phase method, the light emission pattern corresponding to the case of obtaining a gradation image is a light emission pattern that emits light continuously in the period Ds a multiple of two time (i.e., at least twice) in a single frame period F.

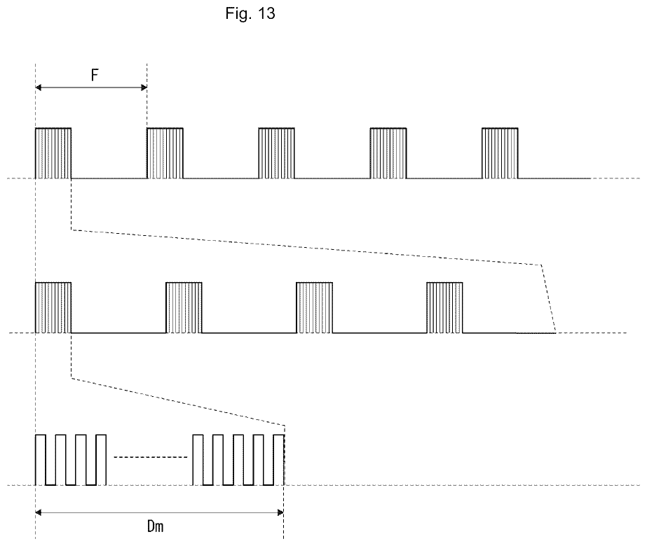

FIG. 13 is a diagram illustrating an example of the light emission pattern corresponding to a case of obtaining a range image in the sensor device 1.

As illustrated in the bottommost section of the figure, when obtaining a range image, light is emitted repeatedly with an ON duty of 50%.

Here, an example will be given of a light emission pattern in which such repeated light emission with an ON duty of 50% is performed a number of times that is a multiple of two (here, this is assumed to be four times) in a single frame period F, under the assumption that rangefinding using the four-phase method is performed. Here, when emitting light repeatedly to obtain a range image, a light emission period corresponding to a single unit of the light reception operation is denoted as “period Dm”, as illustrated.

Note that when obtaining a range image, the ON duty of the light emission drive signal is not limited to 50%, but it is at least desirable that the ON duty be less than or equal to 50%.

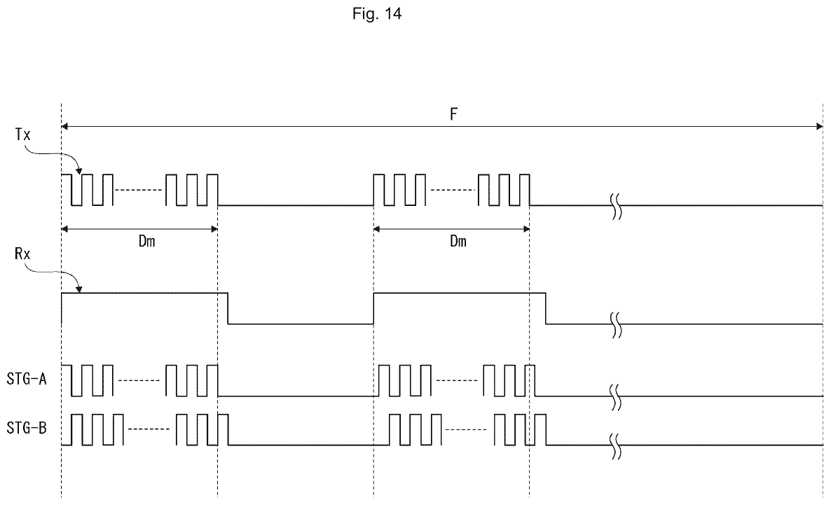

FIG. 14 is a diagram illustrating a relationship between the period Dm of repeated light emission and the charge distribution operation corresponding to when obtaining a range image.

When obtaining a range image, the light emission pattern of the repeated light emission is the same for each unit of the light reception operation performed in one frame period F. In other words, when the unit of the light reception operation is performed four times in one frame period F, as in this example, the light emission pattern corresponding to when obtaining the range image is a light emission pattern in which light is emitted four times repeatedly in the period Dm in synchronization with the execution cycle of the unit of the light reception operation.

Note that the unit of the light reception operation performed using the transfer drive signals STG-A and STG-B is the same when obtaining a range image and when obtaining a gradation image, and thus redundant descriptions will not be given.

Specific examples of light emission patterns corresponding to the processing types of the image use processing will be described hereinafter.

The user authentication processing is assumed to be processing which is performed under the condition that the vehicle is stopped, as can be understood from the descriptions of FIG. 8.

On the other hand, the posture recognition processing is assumed to be processing which is performed while the vehicle is traveling.

Changes in outside light tend to be greater when the vehicle is traveling than when the vehicle is stopped. On the other hand, if it is assumed that a range image is to be obtained, if the period Dm of the repeated light emission is lengthened, the image becomes more susceptible to changes in outside light, which leads to a decrease in rangefinding accuracy.

In addition, because facial authentication and iris authentication are performed in the user authentication processing, it is desirable to increase the light amount as much as possible to improve the contrast, resolution, and the like of the image.

Accordingly, in this example, the light emission pattern is switched, so as to change the amount of light received by the sensor unit 10 per frame, between when the user authentication processing (processing performed while stopped) is performed and when the posture recognition processing (processing performed while traveling) is performed. Specifically, if the user authentication processing is performed, the light emission pattern is switched such that the amount of light received is greater than when the posture recognition processing is performed.

Here, there are also situations where the user authentication processing is performed using the gradation image. In addition, as processing performed while traveling, the attention detection processing is processing performed using the gradation image.

Gradation images are also affected by changes in outside light.

Accordingly, in this example too, the light emission pattern is switched so as to change the amount of light received by the sensor unit 10 per frame, for the user authentication processing and the attention detection processing performed using the gradation image. In other words, the light emission pattern is switched, so as to change the amount of light received, between when the user authentication processing using the gradation image (processing performed while stopped) is performed and, similarly, when the attention detection processing using the gradation image (processing performed while traveling) is performed. Specifically, if the user authentication processing using a gradation image is performed, the light emission pattern is switched such that the amount of light received is greater than when the attention detection processing is performed.

Specific examples of numerical values for the light emission patterns for each processing type of the image use processing will be given hereinafter.

First, for the light emission pattern when using a gradation image in the user authentication processing, the light emission current value (laser power) is set to 4 A (amperes), and the period Ds (the period of continuous light emission at an ON duty of 100%) is set to 560 μs.

In addition, for the light emission pattern when using a range image in the user authentication processing, the period Dm of the repeated light emission is in this example set to twice the aforementioned period Ds (such that the effective light amount is the same as when using a gradation image). In particular, the light emission pattern when using a range image is set to a light emission current value of 4 A, and the period Dm is set to 1,120 μs (about 1 ms).

The light emission pattern corresponding to the posture recognition processing (performed using a range image, in this example) is set such that the amount of light received by the sensor unit 10 per frame is less than when performing the user authentication processing using a range image. For example, the light emission current value is set to 4 A, and the period Dm is set to 280 μs.

The light emission pattern corresponding to the attention detection processing (performed using a gradation image, in this example) is set such that the amount of light received by the sensor unit 10 per frame is less than when performing the user authentication processing using a gradation image. For example, the light emission current value is set to 4 A, and the period Ds is set to 280 μs.

The item forgotten in seat detection processing (performed using a gradation image, in this example) is image use processing performed under the condition that the vehicle is stopped, similar to the user authentication processing. Accordingly, the amount of light received by the sensor unit 10 per frame is greater than when performing the attention detection processing using a gradation image while traveling. For example, the light emission current value is set to 4 A, and the period Dm is set to 840 μs.

Here, as similar processing performed while the vehicle is stopped, the user authentication processing is processing targeted at the driver, i.e., processing targeted only at the front seats in the vehicle, while the item forgotten in seat detection processing is processing targeted at both the front seats and the rear seats. Accordingly, as indicated by the examples of numerical values above, in this example, when performing the item forgotten in seat detection processing (with the rear seat-targeted processing having a period Ds of 840 μs), the light emission pattern is switched so as to increase the amount of light emitted per frame compared to when performing the user authentication processing (with the front seat-targeted processing having a period Ds of 560 μs).

This makes it easier for the irradiated light Li to reach the rear seat, and makes it possible to improve the accuracy of the item forgotten in seat detection processing.

Although the aforementioned emotion estimation processing is processing performed using a range image and processing performed while traveling, it is conceivable that the corresponding light emission pattern will have a light emission current value of 4 A and a period Dm of 280 us, for example.

In the case of such a light emission pattern, the amount of light received by the sensor unit 10 per frame is set to be less than the user authentication processing performed using the same range image and performed while the vehicle is stopped. In other words, in this case too, the processing while stopped is performed as the image use processing using a range image is equivalent to switching the light emission pattern such that the amount of light received is greater than when the processing while traveling is performed.

With respect to the specific examples of numerical values given above, the numerical values of the period Ds, the period Dm, and the light emission current value are merely examples, and can be changed as appropriate according to actual embodiments and the like.

Here, in the sensor device 1 in this example, the operation setting information of the light-emitting unit 11 for implementing the light emission pattern for each processing type, as described in the examples above, is stored as the setting information 15a illustrated in FIG. 3.

In response to a light emission pattern instruction based on the processing type issued from the information processing device 2 (the CPU 21), the control unit 14 of the sensor device 1 controls the light emission operation by the light-emitting unit 11 based on the operation setting information, among the operation setting information stored as the setting information 15a, that corresponds to the instruction from the CPU 21. As a result, the light-emitting unit 11 emits light in a light emission pattern appropriate for the processing type.

### (5-2. HDR)

Light emission patterns used by the light-emitting unit 11 such that High Dynamic Range (HDR) images are obtained by the sensor device 1 as the gradation image and the range image will be described next.

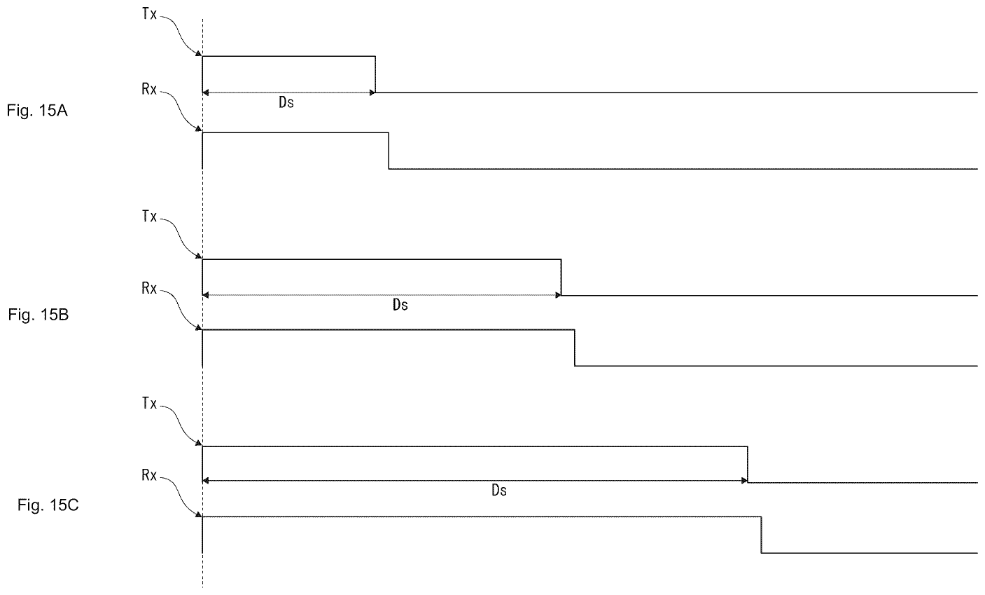

FIG. 15 is an explanatory diagram illustrating a light emission pattern for obtaining an HDR image for the gradation image. A case where a single HDR image is obtained from three gradation images will be described here as an example.

When performing HDR compositing on gradation images, control is performed such that the amount of light emitted by the light-emitting unit 11 is different for each gradation image, as the switching control for the light emission pattern for each gradation image when obtaining a plurality of gradation images to be composited.

Specifically, as illustrated in FIGS. 15A, 15B, and 15C, the length of the continuous light-emission period Ds with an ON duty of 100% is set to short, medium, and long light emission patterns, respectively, as the light emission patterns for obtaining each of the gradation images to be composited.

As described above, in the sensor device 1 of the present embodiment, four units of the light reception operation are performed within a single frame period F. For this reason, a light emission pattern in which the period Ds is short in this case is a light emission pattern in which continuous light emission using the short period Ds is repeated four times in a single frame period F. Likewise, a light emission pattern in which the period Ds is medium or the period Ds is long is a light emission pattern in which continuous light emission using the medium period Ds or the long period Ds is repeated four times in a single frame period F, respectively.

In the image use processing using a gradation image (for example, the user authentication processing, the attention detection processing, and the like described above), the CPU 21 of the information processing device 2 controls the sensor device 1 (the control unit 14) to cause the light-emitting unit 11 to emit light using the light emission pattern for obtaining an HDR image as described above, corresponding to a case where a request to obtain an HDR image as the gradation image has been made. Specifically, the light emission pattern switching control is performed on the control unit 14 such that the light emission patterns for obtaining the respective gradation images to be composited are light emission patterns in which the period Ds is different.

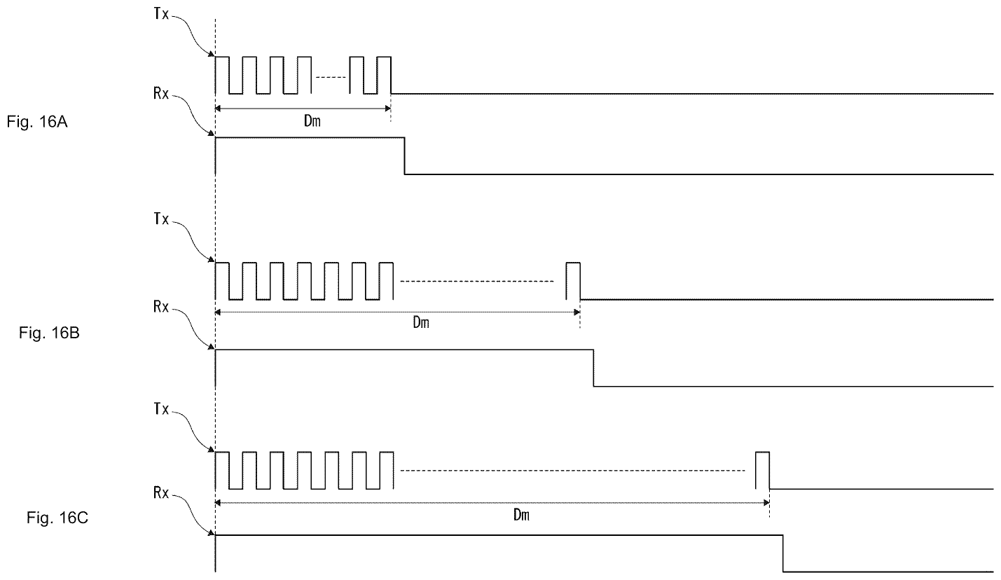

FIG. 16 is an explanatory diagram illustrating a light emission pattern for obtaining an HDR image for a range image. A case where a single HDR image is obtained from three range images will be described as an example.

When performing HDR compositing for range images, as the switching control of the light emission pattern for each range image performed when obtaining a plurality of range images to be composited, control is performed such that the length of the period Dm in which light is repeatedly emitted for rangefinding is different for each range image. Specifically, as illustrated in FIGS. 16A, 16B, and 16C, the length of the period Dm in which light is repeatedly emitted is set to short, medium, and long light emission patterns, respectively, as the light emission patterns for obtaining each of the range images to be composited.

In the present embodiment, the actual light emission patterns using the short period Dm, the medium period Dm, and the long period Dm are light emission patterns in which the continuous light emission in the period Dm is repeated four times in a single frame period F, so as to correspond to the unit of the light reception operation being performed four times in a single frame period F.

Note that, for example, short=140 μs, medium=280 μs, and long=420 μs are conceivable as specific examples of the short, medium, and long periods Dm.

In the image use processing using a range image, e.g., the user authentication processing, the posture recognition processing, and the like described above, the CPU 21 of the information processing device 2 controls the control unit 14 of the sensor device 1 to cause the light-emitting unit 11 to emit light using the light emission pattern for obtaining an HDR image as described above, corresponding to a case where a request to obtain an HDR image as the range image has been made. Specifically, the light emission pattern switching control is performed on the control unit 14 such that the light emission patterns for obtaining the respective range images to be composited are light emission patterns in which the period Dm is different.

Here, if the period Dm of the repeated light emission is set to “long”, the effective light emission amount during the unit of the light reception operation increases, which makes it easier to obtain the reflected light Lr from a distant object. However, the light amount becomes too great for a nearby object, which makes it easy for noise to become intermixed in the distance information of the nearby object (in a gradation image, similar to an image in which blown-out highlights occur when the light amount is too great). Conversely, if the period Dm of the repeated light emission is set to “short”, the effective light emission amount during the unit of the light reception operation decreases, which makes it difficult to obtain the reflected light Lr from a distant object. However, the light amount is appropriate for a nearby object, which makes it easy to obtain low-noise distance information for a nearby object.

As a method for HDR compositing of the range images, it is conceivable to, for the period Dm of the repeated light emission, extract only the pixels of nearby objects (for example, pixels for which the distance information has a high level of confidence) for the range image obtained in a short period Dm, extract only the pixels of the of mid-range objects (pixels for which distance information for an object located between the nearby and far distances is obtained) for the range image obtained in the medium period Dm, extract only the pixels of distant objects for the range image obtained in a long period Dm, and then composite the distance information of the respective extracted pixels as a single range image.

Compositing the respective range images using such a method, for example, makes it possible to obtain a range image in which noise is suppressed from nearby objects to distant objects. In other words, a range image indicating distance information in an appropriate manner from nearby objects to distant objects can be obtained.

Although it is assumed that three light emission patterns, in which the periods Dm are short, medium, and long, are employed as an example of the light emission patterns for obtaining an HDR image, it is possible, depending on the application, to employ two light emission patterns in which the periods Dm are short and medium, or the periods Dm are medium and long, for example. It is also possible to employ four or more light emission patterns.

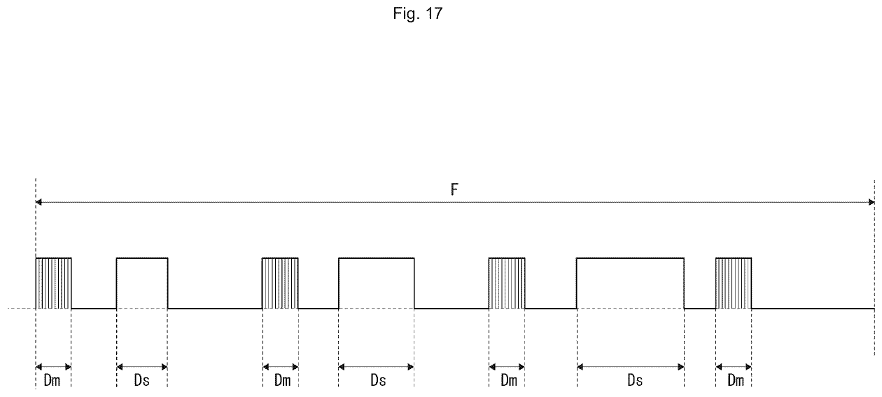

FIG. 17 is an explanatory diagram illustrating a light emission pattern as a variation pertaining to HDR compositing.

As shown in the figure, in this variation, in one frame period F, light is repeatedly emitted in a plurality of times during the period Dm for obtaining a range image, and light is emitted continuously in the period Ds for obtaining a gradation image during each period Dm. At this time, the length of the period Ds is different for each instance of continuous light emission for obtaining the gradation image (in the figure, the period Ds is changed in order from short, to medium, and then to long).

Using such a light emission pattern eliminates the need to separately provide a frame period for obtaining the range image and a frame period for obtaining the gradation image in order to obtain the range image and the gradation image serving as the HDR image, which makes it possible to suppress a drop in the framerate.

### 6. Variation

Note that the embodiment is not limited to the specific examples described above, and configurations serving as a variety of variations can be employed as well.

For example, although the foregoing describes an example of in-vehicle monitoring in which only one sensor device 1 is provided in a vehicle, a configuration in which a plurality of sensor devices 1 are provided, such as one for a front seat and one for a rear seat for a total of two, is also possible, for example.

In addition, the present technique is not limited to being applied to in-vehicle monitoring, and can also be applied in other applications such as indoor monitoring of houses or companies, as well as monitoring outside a vehicle or outside in general.

Additionally, the foregoing assumes that a sensing module SM compatible with the indirect ToF method is used for switching control for the light emission patterns for obtaining an HDR image. However, the switching control for the light emission patterns for obtaining an HDR image can be broadly applied in a favorable manner when a sensing module including a light-emitting unit and a sensor unit that receives light emitted from the light-emitting unit and reflected by an object is used, such as a sensing module for direct ToF or Light Detection and Ranging (LiDAR), a sensing module that combines an IR sensor (an image sensor capable of receiving IR light) with an IR light-emitting unit, a sensing module that combines an RGB IR sensor with an IR light-emitting unit, or the like, for example.

### 7. Summary of Embodiment

As described above, a control device (the information processing device 2) serving as an embodiment includes a control unit (the CPU 21) that performs switching control among at least two types of light emission patterns of a light-emitting unit (11) in a sensing module (SM), the sensing module including the light-emitting unit and a sensor unit (10) configured to be capable of a light reception operation compatible with an indirect ToF method for light emitted from the light-emitting unit and reflected by an object.

In addition to obtaining a range image using the indirect ToF method, the sensor unit compatible with the indirect ToF method can be configured to obtain a gradation image of light in the light emission wavelength band of the light-emitting unit, such as an Infrared (IR) image. As described above, the light emission pattern of the light-emitting unit can be switched, which makes it possible to switch to a light emission pattern suited to the application of the sensor unit, such as switching between a light emission pattern for obtaining a range image and a light emission pattern for obtaining a gradation image, or switching to a light emission pattern according to the processing type of image use processing performed using the image obtained by the sensor unit, for example.

This makes it possible to ensure that a sensor unit configured to be capable of light reception operations compatible with the indirect ToF method obtains an image appropriate for the application thereof.

Additionally, in the control device according to the embodiment, the control unit performs the switching control among the light emission patterns according to a processing type of image use processing performed using an image obtained by the sensor unit (see FIGS. 10 to 14 and the like).

There are various types of processing, such as posture recognition processing for a subject using a range image, authentication processing for a subject using a gradation image, and the like, that correspond to the image use processing. According to the above-described configuration, it is possible to switch to a light emission pattern considered appropriate in accordance with the processing type of the image use processing, such as posture recognition processing, authentication processing, and the like.

This makes it possible to ensure that an image of an appropriate form is used in each instance of image use processing.

Furthermore, in the control device according to the embodiment, the sensor unit is configured to be capable of obtaining a gradation image, and the control unit performs control such that the light emission pattern is switched between when the image use processing is processing using a range image and when the image use processing is processing using a gradation image (see FIGS. 12 to 14 and the like). This makes it possible to cause the light-emitting unit to emit light using a light emission pattern suitable for obtaining the range image when image use processing requiring a range image is performed, and to cause the light-emitting unit to emit light using a light emission pattern suitable for obtaining a range image when image use processing requiring a gradation image is performed.

This makes it possible to ensure that an appropriate image is used in each instance of image use processing.

Furthermore, in the control device according to the embodiment, the control unit causes the light-emitting unit to emit light in a light emission pattern in which light is emitted repeatedly at an ON duty of less than or equal to 50% when the image use processing is processing using a range image, and causes the light-emitting unit to emit light in a light emission pattern in which the ON duty is 100% when the image use processing is processing using a gradation image.

This makes it possible to obtain an appropriate image for each of the range image and the gradation image, and suppresses a drop in the framerate for the gradation image.

Additionally, in the control device according to the embodiment, the control unit performs the switching control among the light emission patterns such that an amount of light received by the sensor unit per frame is changed according to the processing type.

For example, when user authentication processing and attention detection processing are performed as the image use processing, a high-resolution image is required in order to improve the processing accuracy. Accordingly, there are situations where the amount of light received is to be changed when the processing type of the image use processing differs, such as increasing the amount of light received by the sensor unit to improve the contrast.

According to the above-described configuration, the light emission pattern can be controlled such that the amount of light received is appropriate for the processing type of the image use processing.

Furthermore, in the control device according to the embodiment, the control unit performs the switching control among the light emission patterns such that a length of a repeated light emission period (the period Dm) is changed according to a processing type of the image use processing using a range image, the repeated light emission period being a period during which light is emitted repeatedly for rangefinding.

In rangefinding using the indirect ToF method, if the light-receiving period per frame is long, major changes in outside light will have a greater effect, even when light outside the visible light range, e.g., IR light, is used as the light for rangefinding. On the other hand, there may be cases where image use processing using the range image includes processing performed in a scene where the change in outside light is low and processing performed in a scene where the change in outside light is high, such as processing performed while the vehicle is stopped and processing during travel, for example.

According to the above-described configuration, the amount of light received per frame by the sensor unit can be optimized for processing performed in, for example, scenes where changes in outside light are high and scenes where changes in outside light are low, among the types of image use processing that use range images. This makes it possible to improve the processing accuracy of the image use processing.

Further still, in the control device according to the embodiment, as the switching control among the light emission patterns for each of range images when obtaining a plurality of range images to be composited, the control unit performs control such that a length of a repeated light emission period for rangefinding is different for each of the range images (see FIG. 16 and the like).

As a result, a plurality of range images having different lengths for the repeated light emission period can be obtained.

Accordingly, by compositing those range images, a range image indicating appropriate distance information from nearby objects to distant objects can be obtained.

Additionally, in the control device according to the embodiment, as the switching control among the light emission patterns for each of gradation images when obtaining a plurality of gradation images to be composited, the control unit performs control such that a light emission amount of the light-emitting unit is different for each of the gradation images.

Through this, a plurality of images having different brightnesses can be obtained for a gradation image obtained by selectively receiving light in a specific wavelength band, such as an IR image, for example.

Accordingly, when generating a gradation image using a sensor unit compatible with the indirect ToF method, HDR compositing of the gradation images can be performed.

Furthermore, in the control device according to the embodiment, the control device is an in-vehicle device that performs the switching control of the light emission pattern for the light-emitting unit in the sensing module, the sensing module being installed in a vehicle.

Through this, the sensor unit used for in-vehicle monitoring, such as monitoring an occupant in the vehicle, can be switched to a light emission pattern appropriate for the application of the sensor unit.

Accordingly, the sensor unit used for the in-vehicle monitoring can obtain an image appropriate for the application.

Further still, in the control device according to the embodiment, the image use processing performed using an image obtained by the sensor unit includes processing while stopped, performed under a condition that the vehicle is stopped, and processing while traveling, performed while the vehicle is traveling; and the control unit performs the switching control among the light emission patterns such that an amount of light received by the sensor unit per frame is changed between when the processing while stopped is performed and when the processing while traveling is performed.

It can be said that changes in outside light will be low when the vehicle is stopped, whereas changes in outside light will be high when the vehicle is traveling. On the other hand, for example, if the repeated light emission period is lengthened when obtaining a range image (i.e., the amount of light received per frame is increased), the image becomes more susceptible to the effects of changes in outside light, which leads to a decrease in rangefinding accuracy. According to the above-described configuration, the amount of light received can be adjusted appropriately in light of the effects of changes in the outside light, such as, for example, preventing a drop in rangefinding accuracy by making the amount of light received per frame lower during processing while traveling, in which changes in the outside light are high, than during processing while stopped.

This makes it possible to obtain an image appropriate for the magnitude of the change in the outside light as the image used in the image use processing, which in turn makes it possible to improve the accuracy of the image use processing.

Additionally, in the control device according to the embodiment, the vehicle includes, as seats, a front seat including a driver's seat and a rear seat located behind the front seat; the image use processing performed using an image obtained by the sensor unit includes front seat-targeted processing that targets only a front seat side among the front seat and the rear seat, and rear seat-targeted processing that includes the rear seat as a target; and the control unit performs the switching control among the light emission patterns such that an amount of light emitted per frame is greater when the rear seat-targeted processing is performed than when the front seat-targeted processing is performed.

This makes it possible to increase the amount of light emitted so as to handle situations where rear seat-targeted processing that includes the rear seat as a target is performed.

As such, the accuracy of the rear seat-targeted processing can be improved.

A control method according to the embodiment includes performing switching control among at least two types of light emission patterns of a light-emitting unit in a sensing module, the sensing module including the light-emitting unit and a sensor unit configured to be capable of a light reception operation compatible with an indirect ToF method for light emitted from the light-emitting unit and reflected by an object.

The same operations and effects as those of the control device according to the embodiment described above can also be achieved by this control method.

Additionally, a control device according to another embodiment includes a control unit configured to perform switching control of a light emission pattern of a light-emitting unit in a sensing module including the light-emitting unit and a sensor unit that receives light emitted from the light-emitting unit and reflected by an object; and as the switching control among the light emission patterns for each of images when obtaining a plurality of images to be composited, the control unit performs control such that an amount of light received by the sensor unit per frame is changed for each of the images.

As a result, an HDR image can be generated in a system that performs image sensing using a sensing module that includes a light-emitting unit and a sensor unit that receives light emitted from the light-emitting unit and reflected by an object.

Note that the advantageous effects described in the present specification are merely exemplary and are not limited, and other advantageous effects may be obtained.

### 8. Present Technique

Note that the present technique can also be configured as follows.

(1)

A control device including:
a control unit that performs switching control among at least two types of light emission patterns of a light-emitting unit in a sensing module, the sensing module including the light-emitting unit and a sensor unit configured to be capable of a light reception operation compatible with an indirect ToF method for light emitted from the light-emitting unit and reflected by an object.
   (2)

The control device according to (1),
wherein the control unit performs the switching control among the light emission patterns according to a processing type of image use processing performed using an image obtained by the sensor unit.
(3)

The control device according to any one of (2) to (4),
wherein the sensor unit is configured to be capable of obtaining a gradation image, and
the control unit performs control such that the light emission pattern is switched between when the image use processing is processing using a range image and when the image use processing is processing using a gradation image.
   (4)

The control device according to (3),
wherein the control unit causes the light-emitting unit to emit light in a light emission pattern in which light is emitted repeatedly at an ON duty of less than or equal to 50% when the image use processing is processing using a range image, and causes the light-emitting unit to emit light in a light emission pattern in which the ON duty is 100% when the image use processing is processing using a gradation image.
   (5)

The control device according to any one of (2) to (4),
wherein the control unit performs the switching control among the light emission patterns such that an amount of light received by the sensor unit per frame is changed according to the processing type.
   (6)

The control device according to any one of (2) to (5),
wherein the control unit performs the switching control among the light emission patterns such that a length of a repeated light emission period is changed according to a processing type of the image use processing using a range image, the repeated light emission period being a period during which light is emitted repeatedly for rangefinding.
   (7)

The control device according to any one of (1) to (6),
wherein as the switching control among the light emission patterns for each of range images when obtaining a plurality of the range images to be composited, the control unit performs control such that a length of a repeated light emission period for rangefinding is different for each of the range images.
   (8)

The control device according to any one of (1) to (6),
wherein as the switching control among the light emission patterns for each of gradation images when obtaining a plurality of the gradation images to be composited, the control unit performs control such that a light emission amount of the light-emitting unit is different for each of the gradation images.
   (9)

The control device according to any one of (1) to (8),
wherein the control device is an in-vehicle device that performs the switching control of the light emission pattern for the light-emitting unit in the sensing module, the sensing module being installed in a vehicle.
   (10)

The control device according to (9),
wherein image use processing performed using an image obtained by the sensor unit includes processing while stopped, performed under a condition that the vehicle is stopped, and processing while traveling, performed while the vehicle is traveling, and
the control unit performs the switching control among the light emission patterns such that an amount of light received by the sensor unit per frame is changed between when the processing while stopped is performed and when the processing while traveling is performed.
   (11)

The control device according to (9) or (10),
wherein the vehicle includes, as seats, a front seat including a driver's seat and a rear seat located behind the front seat,
image use processing performed using an image obtained by the sensor unit includes front seat-targeted processing that targets only a front seat side among the front seat and the rear seat, and rear seat-targeted processing that includes the rear seat as a target, and
the control unit performs the switching control among the light emission patterns such that an amount of light emitted per frame is greater when the rear seat-targeted processing is performed than when the front seat-targeted processing is performed.
   (12)

A control method including performing switching control among at least two types of light emission patterns of a light-emitting unit in a sensing module, the sensing module including the light-emitting unit and a sensor unit configured to be capable of a light reception operation compatible with an indirect ToF method for light emitted from the light-emitting unit and reflected by an object.

### REFERENCE SIGNS LIST

1 Sensor device
2 Information processing device
3 Control target device
Fv Field of view
SM Sensing module
Ob Object
Li Irradiated light
Lr Reflected light
Sensor unit
11 Light-emitting unit
11a Light-emitting element
12 Image generation unit
13 Image memory
14 Control unit
Non-volatile memory
15a Setting information
16 Communication I/F (interface)
Px Pixel
111 Pixel array unit
120 Row drive line
121, 121-A, 121-B Gate drive line
122, 122-A, 122-B Vertical signal line
PD Photodiode
FD, FD-A, FD-B Floating diffusion
TG, TG-A, TG-B Transfer transistor
STG, STG-A, STG-B Transfer drive signal
SSEL Selection signal
Ds, DmPeriod

1. A control device comprising:
a control unit that performs switching control among at least two types of light emission patterns of a light-emitting unit in a sensing module, the sensing module including the light-emitting unit and a sensor unit configured to be capable of a light reception operation compatible with an indirect ToF method for light emitted from the light-emitting unit and reflected by an object.

2. The control device according to claim 1,
wherein the control unit performs the switching control among the light emission patterns according to a processing type of image use processing performed using an image obtained by the sensor unit.

3. The control device according to claim 2,
wherein the sensor unit is configured to be capable of obtaining a gradation image, and
the control unit performs control such that the light emission pattern is switched between when the image use processing is processing using a range image and when the image use processing is processing using a gradation image.

4. The control device according to claim 3,
wherein the control unit causes the light-emitting unit to emit light in a light emission pattern in which light is emitted repeatedly at an ON duty of less than or equal to 50% when the image use processing is processing using a range image, and causes the light-emitting unit to emit light in a light emission pattern in which the ON duty is 100% when the image use processing is processing using a gradation image.

5. The control device according to claim 2,
wherein the control unit performs the switching control among the light emission patterns such that an amount of light received by the sensor unit per frame is changed according to the processing type.

6. The control device according to claim 2,
wherein the control unit performs the switching control among the light emission patterns such that a length of a repeated light emission period is changed according to a processing type of the image use processing using a range image, the repeated light emission period being a period during which light is emitted repeatedly for rangefinding.

7. The control device according to claim 1,
wherein as the switching control among the light emission patterns for each of range images when obtaining a plurality of the range images to be composited, the control unit performs control such that a length of a repeated light emission period for rangefinding is different for each of the range images.

8. The control device according to claim 1,
wherein as the switching control among the light emission patterns for each of gradation images when obtaining a plurality of the gradation images to be composited, the control unit performs control such that a light emission amount of the light-emitting unit is different for each of the gradation images.

9. The control device according to claim 1,
wherein the control device is an in-vehicle device that performs the switching control of the light emission pattern for the light-emitting unit in the sensing module, the sensing module being installed in a vehicle.

10. The control device according to claim 9,
wherein image use processing performed using an image obtained by the sensor unit includes processing while stopped, performed under a condition that the vehicle is stopped, and processing while traveling, performed while the vehicle is traveling, and
the control unit performs the switching control among the light emission patterns such that an amount of light received by the sensor unit per frame is changed between when the processing while stopped is performed and when the processing while traveling is performed.

11. The control device according to claim 9,
wherein the vehicle includes, as seats, a front seat including a driver's seat and a rear seat located behind the front seat,
image use processing performed using an image obtained by the sensor unit includes front seat-targeted processing that targets only a front seat side among the front seat and the rear seat, and rear seat-targeted processing that includes the rear seat as a target, and
the control unit performs the switching control among the light emission patterns such that an amount of light emitted per frame is greater when the rear seat-targeted processing is performed than when the front seat-targeted processing is performed.

12. A control method comprising performing switching control among at least two types of light emission patterns of a light-emitting unit in a sensing module, the sensing module including the light-emitting unit and a sensor unit configured to be capable of a light reception operation compatible with an indirect ToF method for light emitted from the light-emitting unit and reflected by an object.

13. A control device comprising:
a control unit configured to perform switching control of a light emission pattern of a light-emitting unit in a sensing module including the light-emitting unit and a sensor unit that receives light emitted from the light-emitting unit and reflected by an object,
wherein as the switching control among the light emission patterns for each of images when obtaining a plurality of the images to be composited, the control unit performs control such that an amount of light received by the sensor unit per frame is changed for each of the images.
